(19) United States
(12) Patent Application Publication
(10) Pub. No.: US 2015/0199912 A1
(43) Pub. Date: Jul. 16, 2015

(54) METHODS AND SYSTEMS FOR A STUDENT GUIDE, SMART GUIDE, AND TEACHER INTERFACE

(71) Applicant: FreshGrade Education, Inc., Kelowna (CA)

(72) Inventors: Steve Wandler, Kelowna (CA); Cayley Humphries, Kelowna (CA); Nathan Karsgaard, Kelowna (CA); Myroslav Pomazan, Kelowna (CA); Mark Payne, Kelowna (CA); Lane Merrifield, Kelowna (CA)

(21) Appl. No.: 14/588,207

(22) Filed: Dec. 31, 2014

Related U.S. Application Data
(60) Provisional application No. 61/922,524, filed on Dec. 31, 2013.

(51) Int. Cl. G09B 5/12

(52) U.S. Cl. CPC G09B 5/125

(57) ABSTRACT

Methods and systems for providing smart guides for teachers, students, parents, and administrators are provided herein. In one embodiment, a teacher guide includes a web-based interface that receives information transmitted by a teacher electronic, the information including at least one of a course curriculum, a lesson plan, a learning objective, an educational activity associated with a specific learning objective, and evidence of learning by a student. The guide also receives an assessment of the student progress on attaining the learning objective, or a suggestion, based on the assessment of a student progress, to the teacher of an individualized learning resource from a resource database that could assist the student in attaining the learning objective. Communication is also provided, enabling the teacher to provide at least one of the student and the parent with at least one of an individualized feedback and a learning resource.

### CROSS REFERENCE TO RELATED APPLICATIONS

This application claims the priority benefit of U.S. Provisional Application Ser. No. 61/922,524, filed on Dec. 31, 2013, titled “METHODS AND SYSTEMS FOR A STUDENT GUIDE, SMART GUIDE, AND TEACHER INTERFACE”, which is hereby incorporated by reference herein in its entirety including all references cited therein.

### FIELD OF THE TECHNOLOGY

Embodiments of the disclosure relate to systems and methods for creating a student portfolio of evidence of learning, enabling formative assessment of a student's work, and providing a Smart Guide for students, teachers, and parents. The Smart Guide analyzes data comprising formative assessments of the student's work and suggests individualized learning resources based on the outcome of the analysis.

### BACKGROUND OF THE DISCLOSURE

Due to limited teaching resources, education in the classroom is largely based on a “one size fits all” model. However, each student is unique in his or her learning style. Thus, many students could benefit from education that is individually tailored to meet their individual needs and learning styles. Teachers generally know what each individual student needs in order to improve his or her progress in the classroom, but teachers often lack the time and resources to create individualized teaching plans for each student.

Additionally, parents may also want to be more involved with their children's education. However, parents may not always have easy access to their children's activities and performance in the classroom and may not have an easy means of communicating with teachers.

### SUMMARY

According to some embodiments, the present technology is directed to method for providing an individualized learning resource to a student, the method comprising: (a) executing, by a server, a web application, the web application creating a web-based graphical user interface associated with a teacher account; (b) receiving, by the server, information transmitted by a teacher electronic device via the web-based graphical user interface, the information comprising at least one of a course curriculum, a lesson plan, a learning objective, an educational activity associated with a specific learning objective, and an evidence of learning by a student; (c) executing, by the server, an assessment algorithm, the assessment algorithm generating an assessment of a student progress on attaining the learning objective; (d) transmitting, from the server to the teacher electronic device via the web-based graphical user interface, information comprising: (i) the assessment of the student progress on attaining the learning objective; (ii) a suggestion, based on the assessment of a student progress, to the teacher of an individualized learning resource from a resource database that could assist the student in attaining the learning objective; (iii) an electronic communication from the student and a parent of the student; and (e) enabling, by the server, an electronic communication between a teacher account and at least one of a student account and a parent account, the electronic communication enabling the teacher to provide at least one of the student and the parent with at least one of an individualized feedback and a learning resource.

According to some embodiments, the present technology is directed to a method for providing an individualized learning resource to a student, the method comprising: (a) executing, by a server, a web application, the web application creating a web-based graphical user interface associated with a student account; (b) transmitting, from the server to a student electronic device via the web-based graphical user interface, information comprising: (i) an assessment of a student learning progress in an academic subject or in relation to a learning objective; (ii) an individualized learning resource from a resource database that assists the student in mastering the academic subject or the learning objective; (iii) an individualized learning resource from a resource database that assists the student in preparing for an upcoming educational activity or lesson; (iv) a homework assignment assigned by a teacher; (iv) an electronic communication from the teacher, the electronic communication including a feedback on a student learning progress provided by the teacher; (c) receiving, by the server, information transmitted by the student electronic device via the web-based graphical user interface, the information comprising at least one of a homework and an activity completed by the student, a document, a video or audio file, or other evidence of learning created by the student; and (d) enabling, by the server, electronic communication between the student account and a teacher account, the electronic communication enabling the student to provide the teacher with a feedback and to ask the teacher a question

According to some embodiments, the present technology is directed to method for providing an individualized learning resource to a student, the method comprising: (a) executing, by a server, a web application, the web application creating a web-based graphical user interface associated with a parent account; (b) transmitting, from the server to a parent electronic device via the web-based graphical user interface, information comprising: (i) an assessment of a student learning progress in an academic subject or in relation to a learning objective; (ii) a suggestion, based on the assessment of the student learning progress, to the parent of an individualized learning resource from a resource database that could assist the student in mastering an academic subject or a learning objective; (iii) a feedback on the student learning progress provided by a teacher; (iv) at least one of a document, a video or audio file, and other evidence of learning by the student; and (c) enabling, by the server, electronic communication between the parent account and a teacher account, the electronic communication providing the parent with immediate access to the teacher.

According to some embodiments, the present technology is directed to a method for providing an electronic report card for a student, the method comprising: (a) executing, by a server, a web application, the web application creating a web-based graphical user interface associated with a parent account; and (b) transmitting, from the server to a parent electronic device via the web-based graphical user interface in the form of a report card, the report card comprising: (i) a selectable list of subjects, each of the subjects being associated with a grade, wherein selection of a subject of the list causes the display of learning objectives for the student, each of the learning objectives having an indication of whether the student completed or failed, wherein selection of a failed objective causes the display of teacher feedback that describes why the student failed at the learning objective.

### BRIEF DESCRIPTION OF THE DRAWINGS

The accompanying drawings, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1A is a schematic diagram of an example smart guide server, which is configured to practice aspects of the present technology.

FIG. 1B is a flowchart of an example method executed in accordance with the present technology;

FIG. 1C is a flowchart of another example method executed in accordance with the present technology;

FIG. 1D is a flowchart of yet another example method executed in accordance with the present technology;

FIGS. 2A-B are collectively a screen shot of one embodiment of a web-based graphical user interface that can be accessed by a teacher.

FIGS. 3A-B are collectively a screen shot of one embodiment of a teacher activity page.

FIGS. 4A-B are collectively a screen shot of one embodiment of a web-based graphical user interface that can be accessed by a student.

FIGS. 5 A-B are collectively a screen shot of one embodiment of a student report.

FIG. 6A-C are collectively a screen shot of one embodiment of a web-based graphical user interface that can be accessed by a parent.

FIG. 7 shows a diagrammatic representation of a computing device for a machine in the exemplary electronic form of a computer system, within which a set of instructions for causing the machine to perform any one or more of the methodologies discussed herein can be executed.

FIG. 8 is a screen shot of one embodiment of various assessment tools.

FIG. 9 is a screen shot of one embodiment of an image file, in a horizontal orientation, from a student portfolio.

FIG. 10 is a screen shot of one embodiment of an image file, in a vertical orientation, from a student portfolio.

FIG. 11 is a screen shot of one embodiment of an audio file from a student portfolio.

FIG. 12 is a screen shot of one embodiment of a document file from a student portfolio.

FIG. 13 is a screen shot of one embodiment of a video file from a student portfolio.

FIG. 14 is a screen shot of one embodiment of a teacher activity plan.

FIG. 15 is a screen shot of one embodiment of a teacher activity plan.

FIG. 16 is a screen shot of one embodiment of a web-based graphical user interface that can be accessed by a school district administrator.

FIG. 17 is a screen shot of one embodiment of a web-based graphical user interface that can be accessed by a parent.

FIG. 18 is a screen shot of one embodiment of a student project page.

FIG. 19 is a screen shot of one embodiment of a student report.

FIG. 20 is a screen shot of one embodiment of a web-based graphical user interface that can be accessed by a student.

FIG. 21 is a screen shot of one embodiment of a web-based graphical user interface that can be accessed by a teacher on which the performance of students in a specific class on a specific subject is displayed.

FIG. 22 is a screen shot of one embodiment of a teacher activity page.

FIG. 23 is a screen shot of one embodiment of the browser window in which the web-based graphical user interface is displayed.

FIG. 24 is a screen shot of one embodiment of a student report card displaying letter grades.

FIG. 25 is a screen shot of one embodiment of a student report card displaying letter grades.

FIG. 26 is a screen shot of one embodiment of a student report card showing a student's mastery of various subjects.

FIG. 27 is a screen shot of one embodiment of a student report card showing a student's mastery of various subjects.

FIG. 28 is a screen shot of one embodiment of a student report card.

FIG. 29 is a screen shot of one embodiment of a student report card.

FIG. 30 is a screen shot of one embodiment of a student report card displaying percentages.

FIG. 31 is a screen shot of one embodiment of a student report card displaying percentages.

FIG. 32 is a screen shot of one embodiment of a teacher settings page where no report measurement scale has been selected.

FIG. 33 is a screen shot of one embodiment of a teacher settings page where the mastery scale has been selected.

FIG. 34 is a screen shot of one embodiment of a teacher settings page where the letter-grade option has been selected.

FIG. 35 is a screen shot of one embodiment of a teacher settings page where the percentage option has been selected.

FIG. 36 is a screen shot of one embodiment of a teacher mobile application.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of the discussion herein, a singular term may include its plural forms and a plural term may include its singular form. Similarly, a hyphenated term (e.g., “on-demand”) may be occasionally and interchangeably used with its non-hyphenated version (e.g., “on demand”), and a capitalized entry (e.g., “Software”) may be interchangeably used with its non-capitalized version (e.g., “software”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Generally speaking, the present technology is directed to systems and methods that provide interactive mechanisms for students, teachers, and parents to engage in the teaching and learning experience in unique ways, enhancing collaboration between students, teachers, and parents. The present technology also creates transparency within the educational process, providing parents with visibility into the classroom using media rich features.

In some embodiments, the present technology provides school administrators with a big data view on the collective progress of their students and teachers in real time, as well as insight into parental engagement with the student's progress.

Parents receive progress reports and report cards that are information rich and tailored to convey information about how the student is progressing in any given task, learning objective, or overall subject. These and other advantages of the present technology are provided below with reference to the collective drawings.

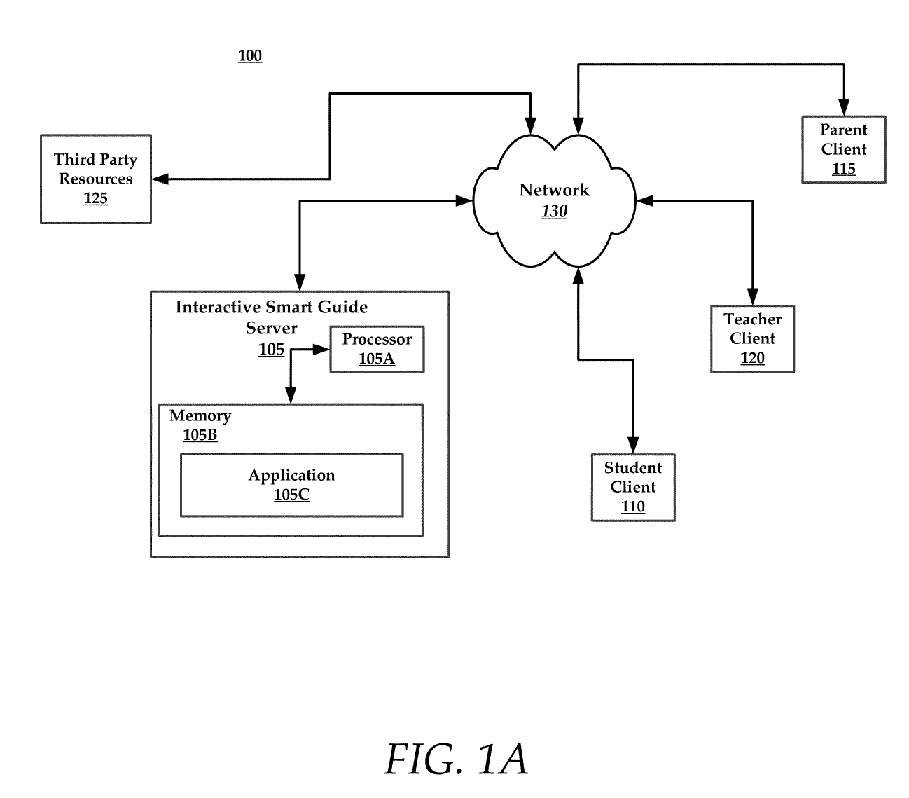

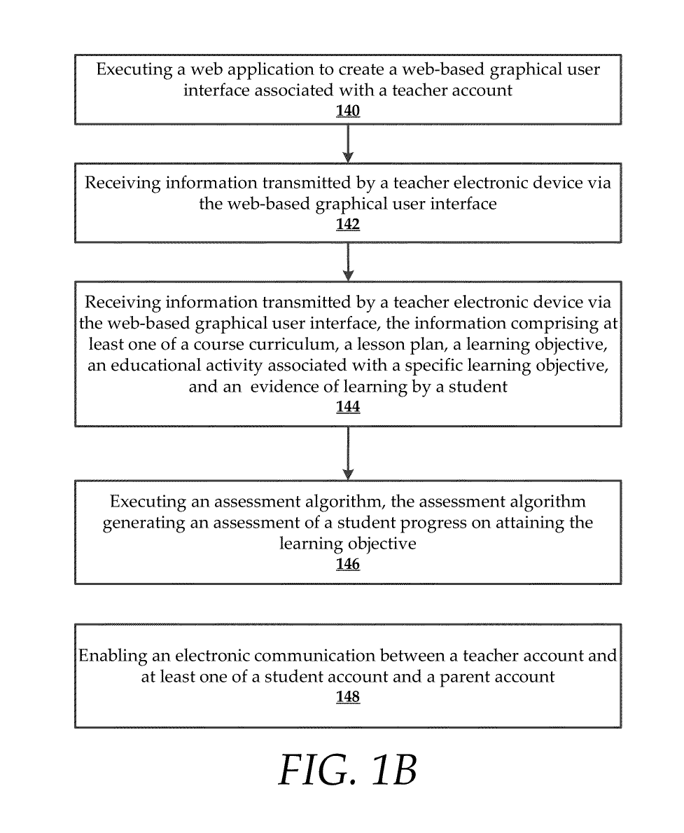

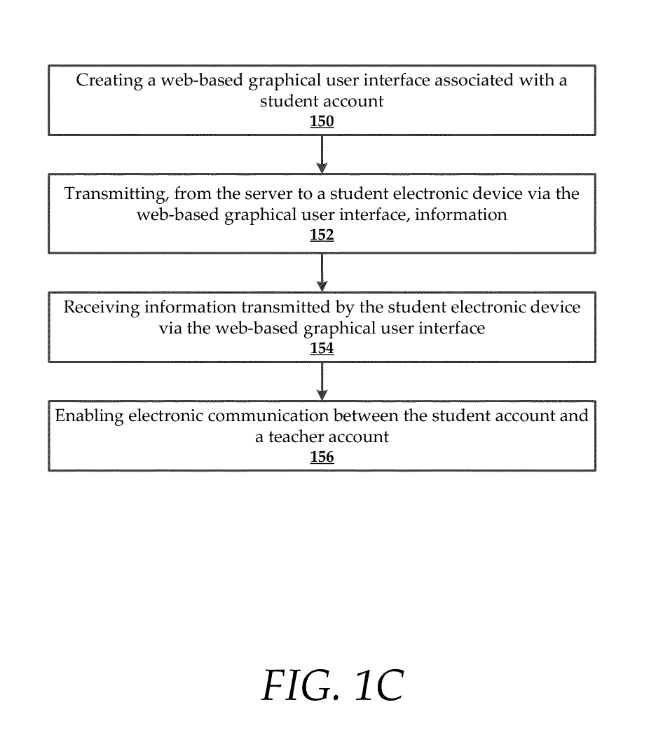

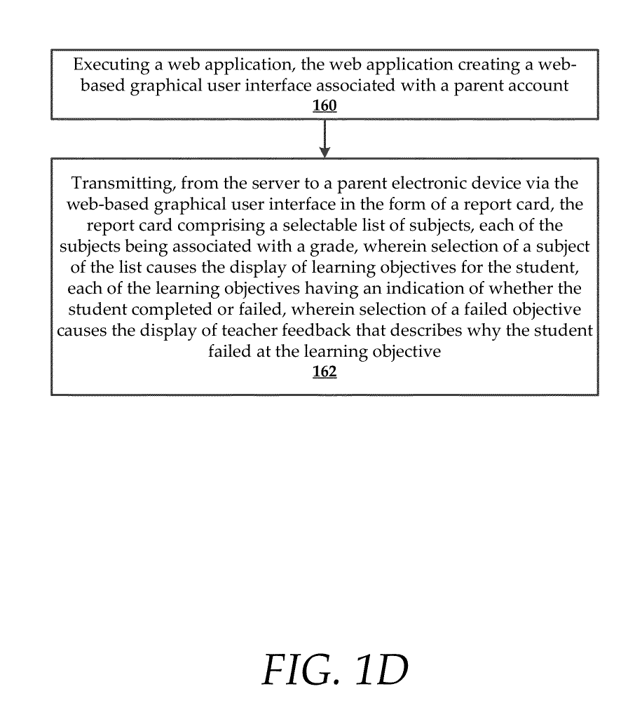

FIG. 1A is a schematic diagram of an example computing architecture 100 that is used to practice aspects of the present technology. The architecture 100 comprises an interactive smart guide server (hereinafter “server 105”). End users such as students, parents, teachers, and school administrators can interact with the server 105 using various end user computing devices. In one embodiment, the architecture includes a student client 110, a parent client 115, and a teacher client 120. Additional other clients can be included in the architecture 100 as needed. For example, an administrator client could also be included in the architecture 100.

In some embodiments the server 105 is also configured to communicatively couple with various third party resources to obtain educational resources that will benefit the interactive processes described herein.

In furtherance of education objectives and collaborative learning experiences provided by the present technology, the server 105 is configured to couple with third party resources 125 to store student data. For example, the third party resources 125 could include cloud storage. In another embodiment, the third party resources 125 include educational materials such as e-books, audio, video, and other similar resources that can be included in an individual education plan for a student.

Each of the components of the architecture 100 described above can be communicatively coupled using a network 130. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network.

The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The server 105 in some embodiments comprises a processor 105A and a memory 105B for storing executable instructions. The processor 105A executes the instructions stored in memory 105B to perform various functionalities and methods described herein. To be sure, the server 105 is programmed as a specific purpose computing device. In one embodiment, the memory 105B stores a web interface application 105C that generates various user interfaces of the present technology.

Generally, the server 105 is configured to provide web-based interfaces that allow end users to utilize a smart guide, referred to also as a collaborative platform. To be sure, while the examples herein are described with reference to the server 105, the web-based interfaces can also be generated by an end user client that executes an application “App” that provides the functionalities described herein. Also, in some embodiments, parts of the web-based interfaces can be generated by the server 105, while other GUIs can be generated at the end user client.

Also, the server 105 can be used to create and store user profiles/records for students, teachers, administrators, parents, or any other end user of the server 105.

Various types of smart guides can be generated by the server 105. For example, the server 105 can generate a student smart guide, a parent smart guide, and a teacher smart guide. Teachers can create activities and assessment records.

A Smart Guide functions to facilitate individualized learning. The Smart Guide allows teachers to set learning objectives and capture evidence of learning by each student. Evidence of learning may include anecdotal notes by the teacher, photographs, audio and video recordings, and documents created by the student that demonstrate the student's understanding of each academic subject or learning objective. The teacher uploads each student's evidence of learning onto the server, and the evidence of learning is compiled in a student portfolio that can be visualized by the student and the student's parent. The evidence of learning can be stored in an assessment record.

The teacher assesses each individual student's progress in mastering each learning objective. The assessment can be based on each student's portfolio, each student's performance on various learning activities, or each student's learning progress. Based on the assessment of each student's progress, the Smart Guide recommends to the teacher individualized learning resources that could assist each student in improving his or her progress on each learning objective. The teacher would then have the option to send the individualized learning resources to each student and the student's parent.

The learning resources are provided by third-party resource providers and are collected and stored in a learning-resource database. In one embodiment, the Smart Guide rates the effectiveness of each learning resource.

A parent Smart Guide facilitates teacher-parent communication by creating a simple and direct channel of communication between the teacher and each student's parent. For example, in one embodiment, the parent Smart Guide allows the teacher to share success stories and updates with parents. The parent Smart Guide also facilitates teacher-student communication by enabling the teacher to provide feedback to each student, send individualized learning resources and homework assignments to each student, and receive questions or comments from each student via the web-based graphical user interface.

The parent Smart Guide apprises parents of their children's progress in the classroom, provides them with learning resources that could assist their children in mastering current learning objectives, and provides them with their children's report card. As illustrated herein, the report card is non-traditional in the sense that it focuses on student progress (i.e., improvement) rather than on an absolute measure of the student's performance (i.e., a letter grade). As explained above, the parent Smart Guide also allows a parent to communicate directly with his or her child's teacher.

A student Smart Guide apprises students of upcoming activities, provides them with learning materials to prepare for those activities, and allows them to access teacher feedback, individualized learning resources, and homework assignments.

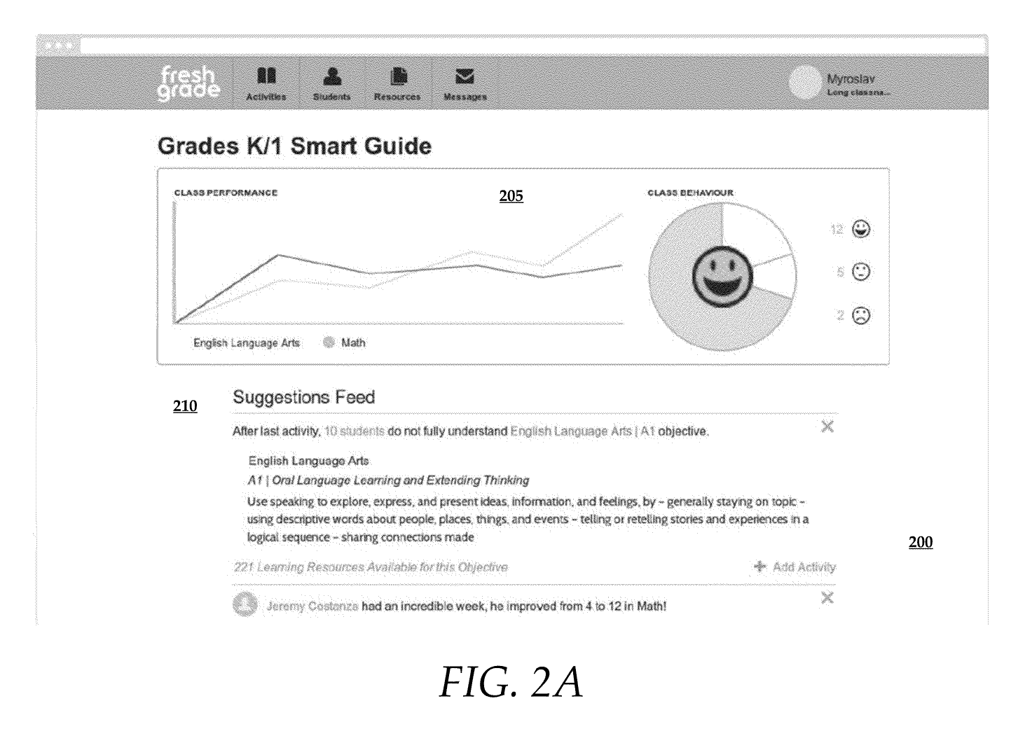

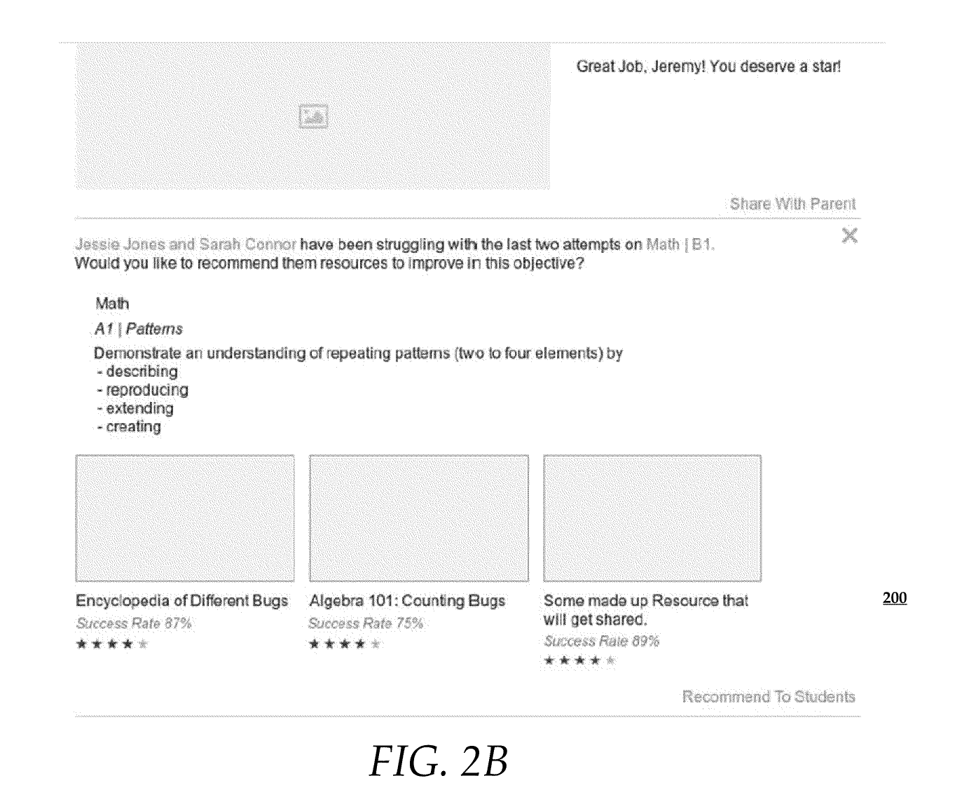

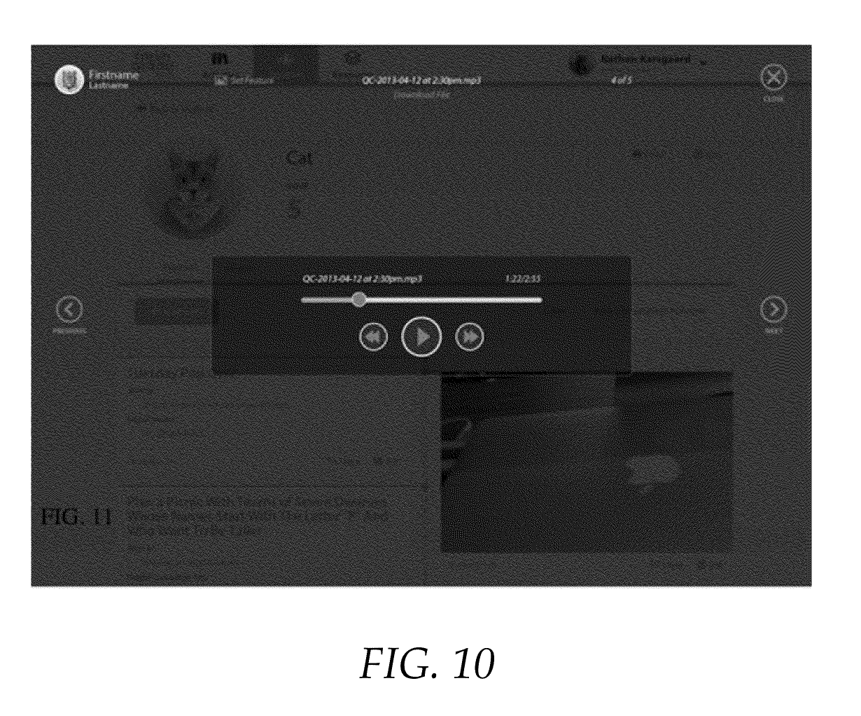

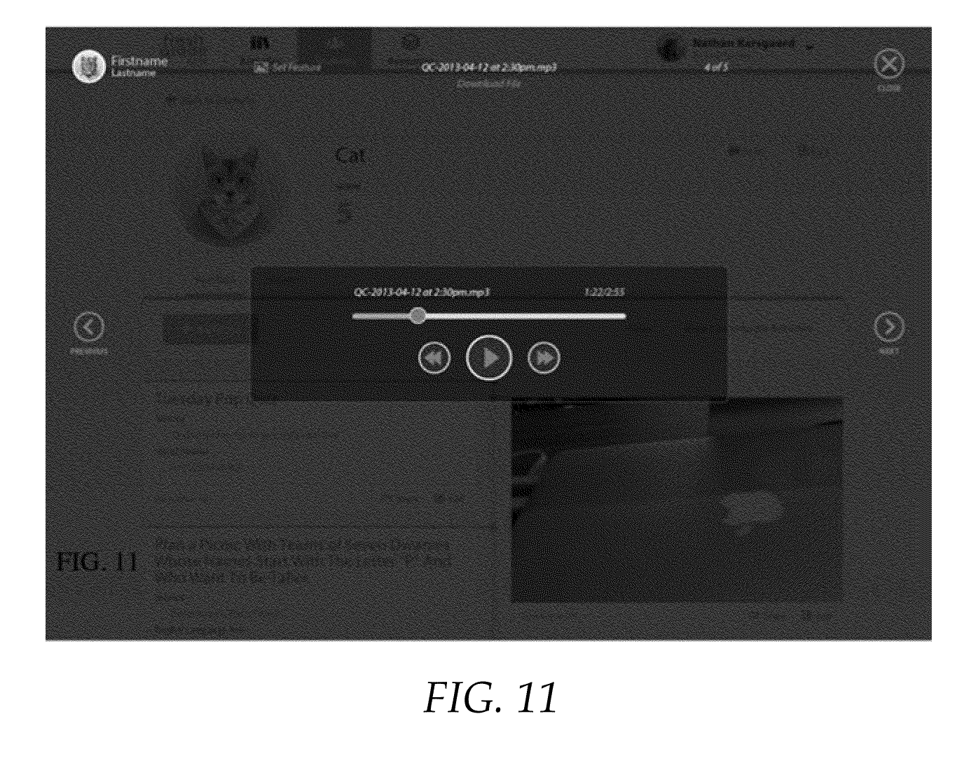

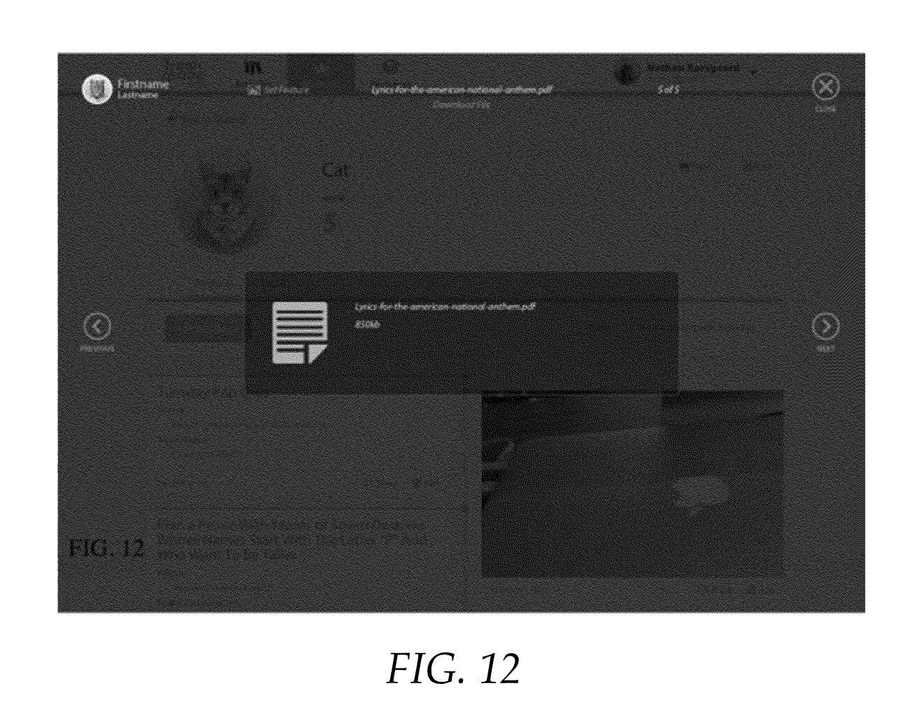

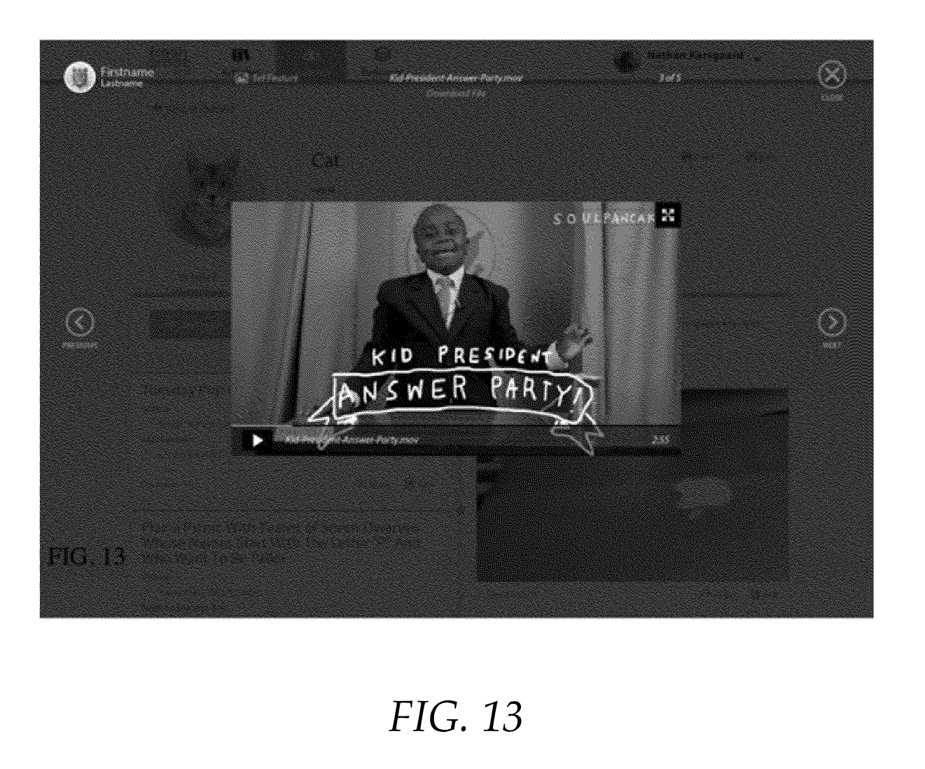

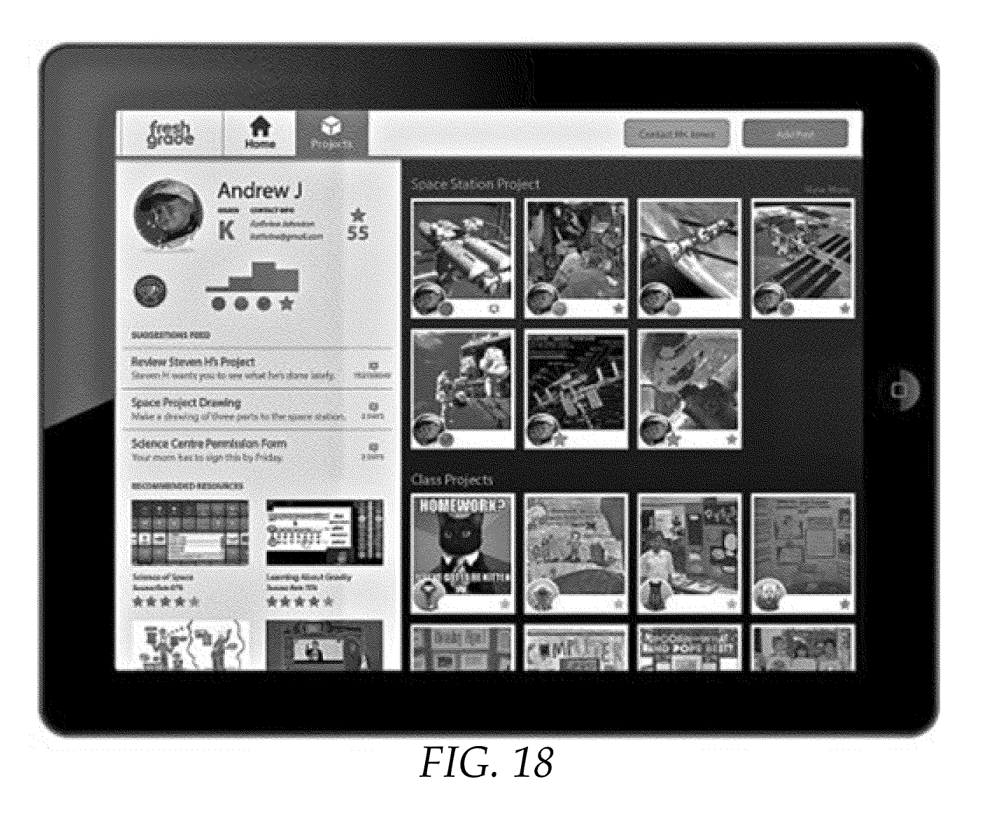

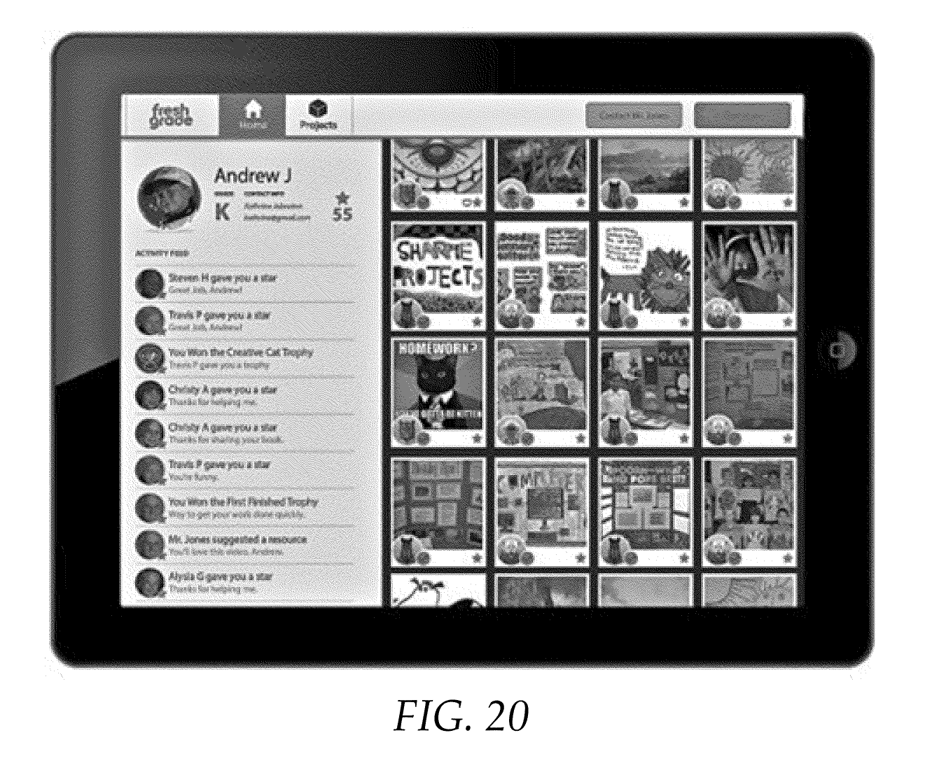

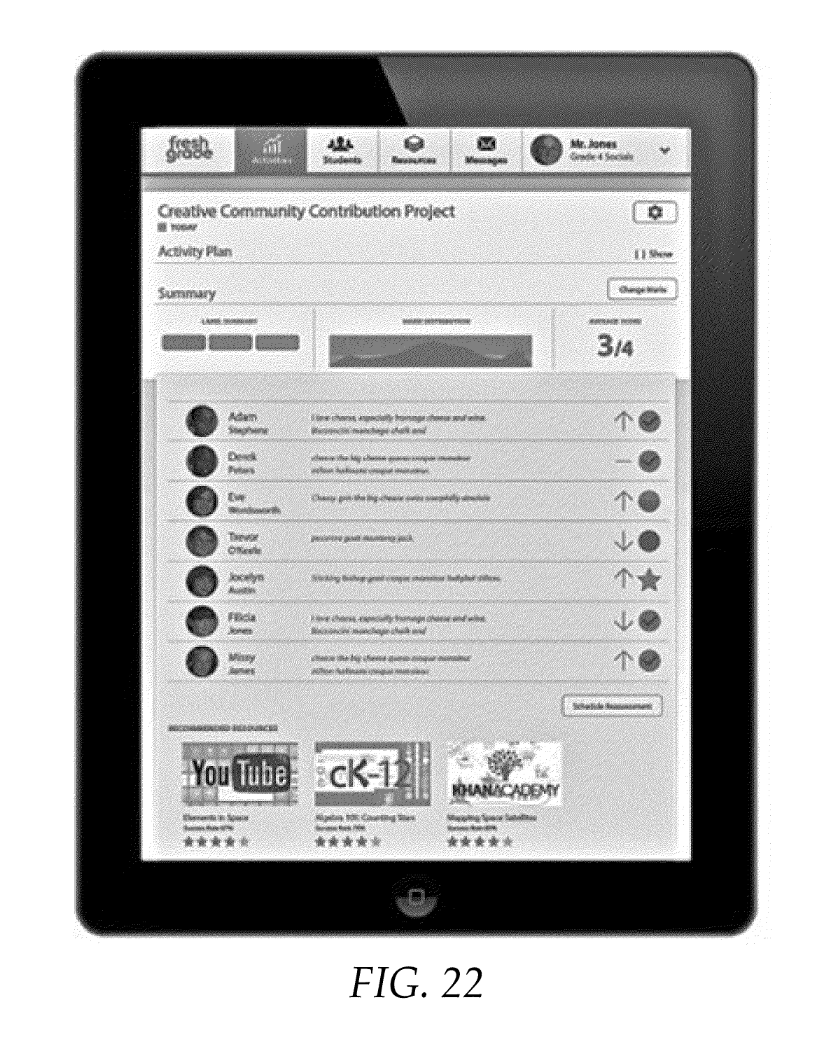

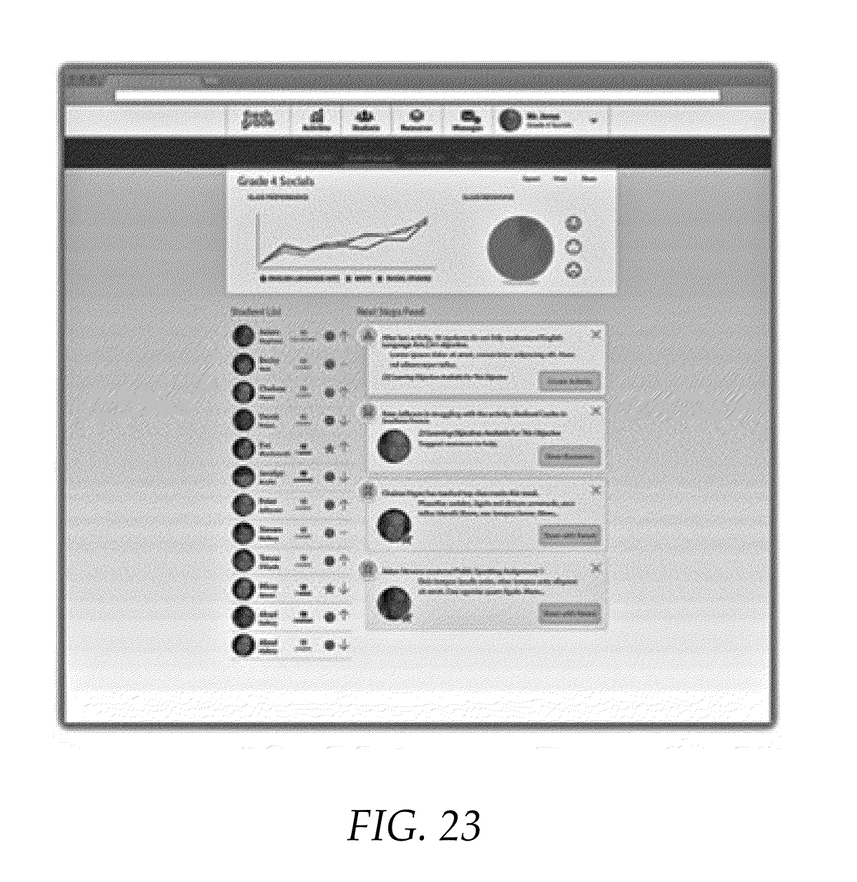

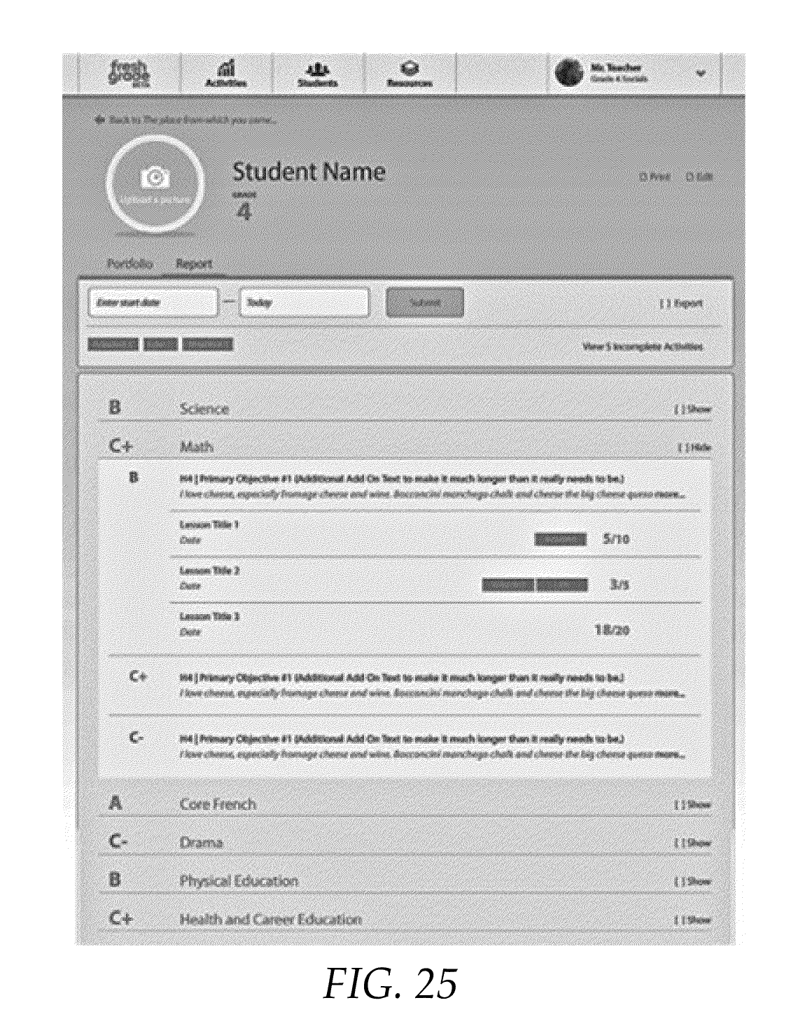

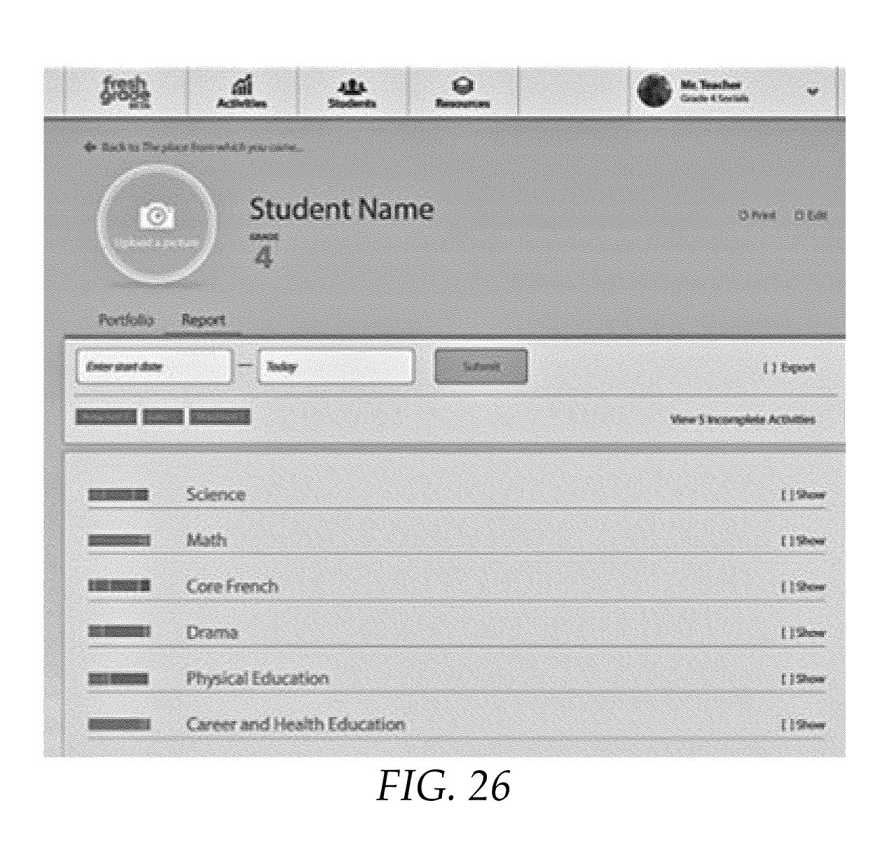

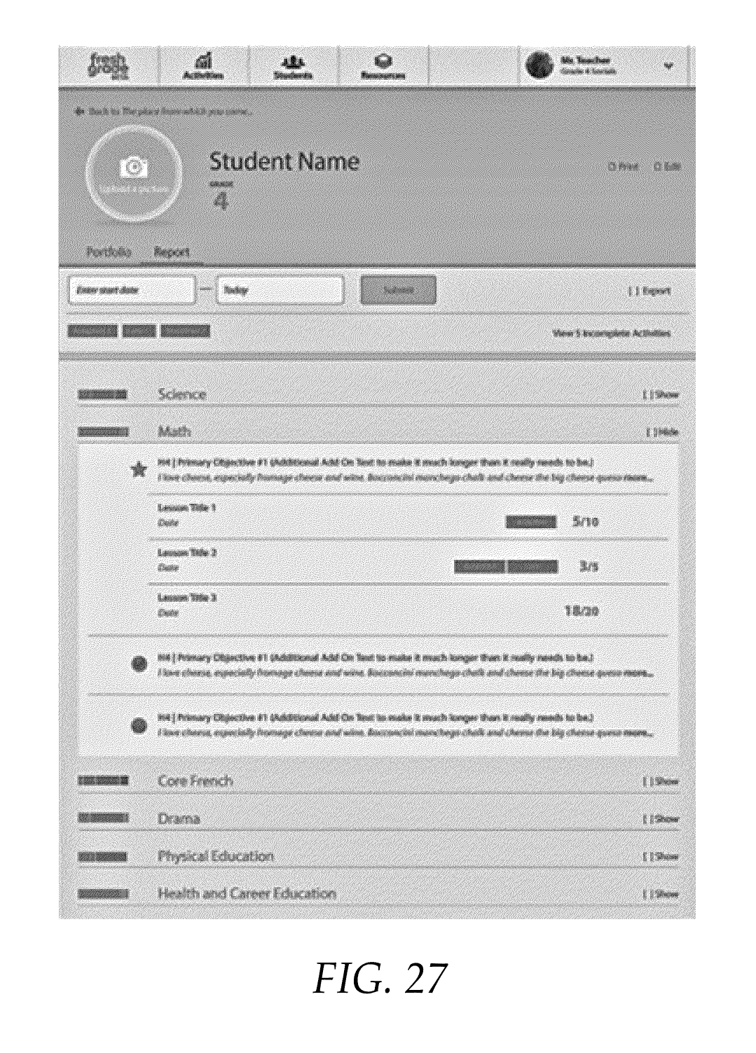

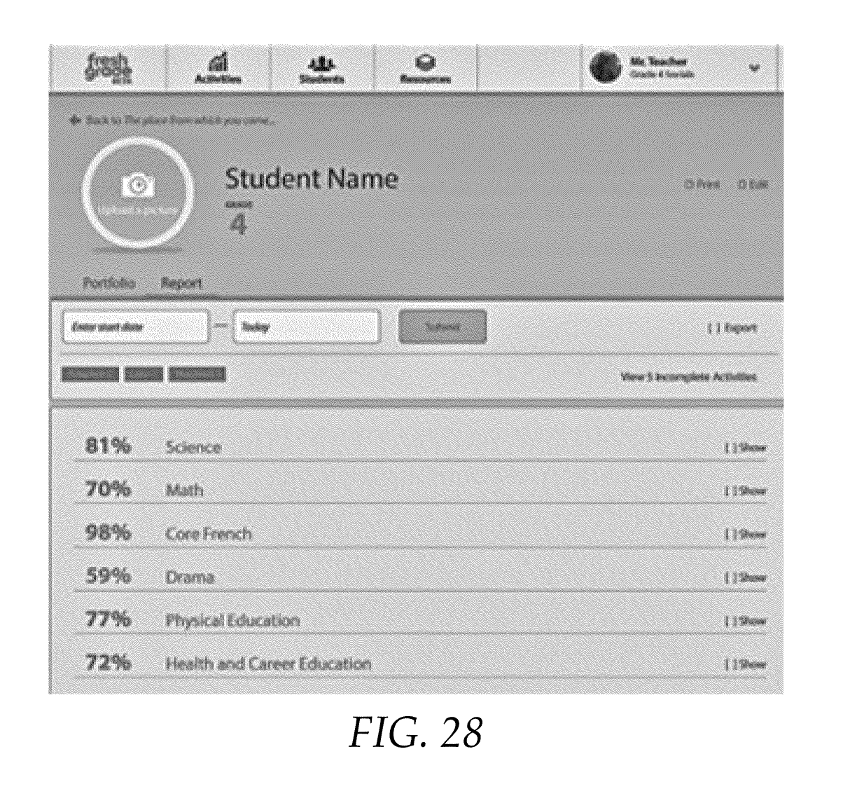

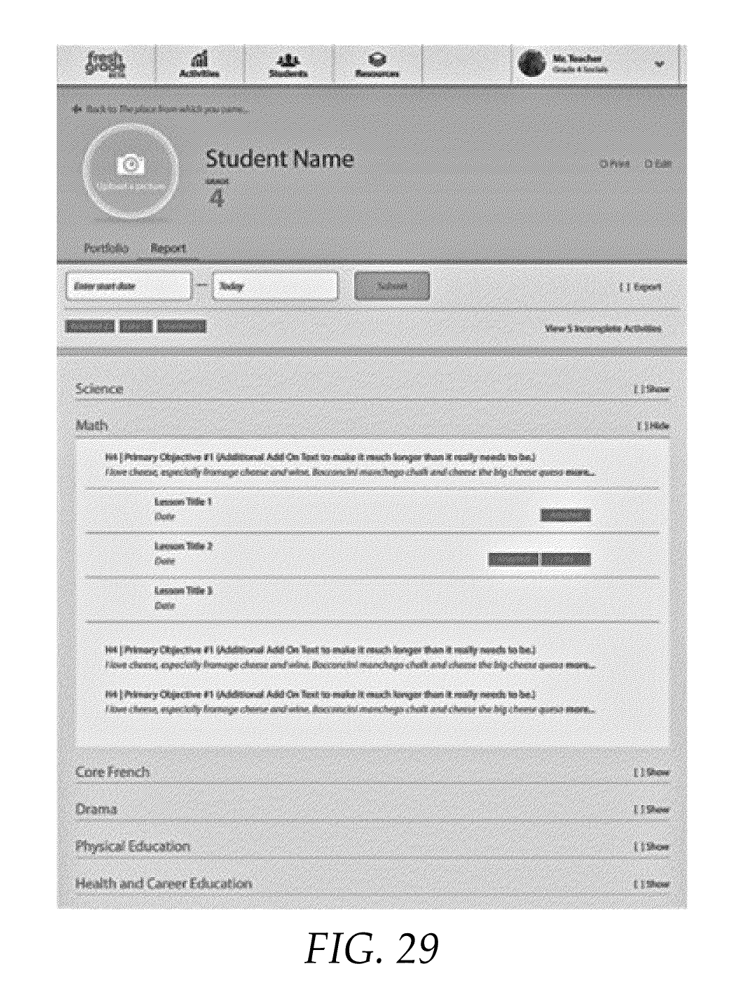

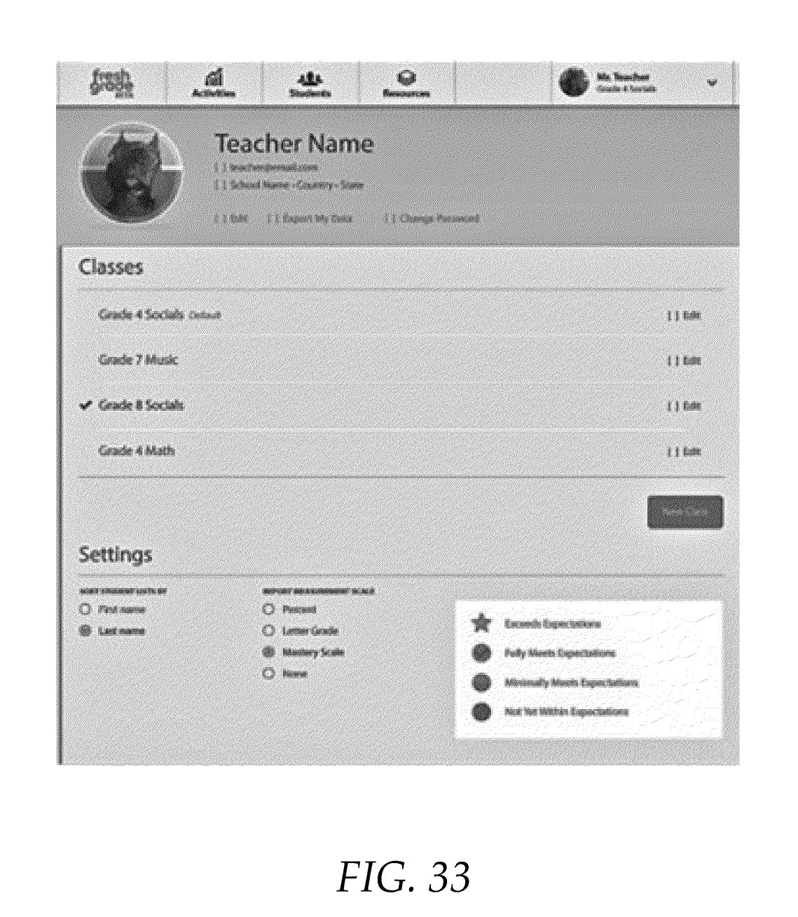

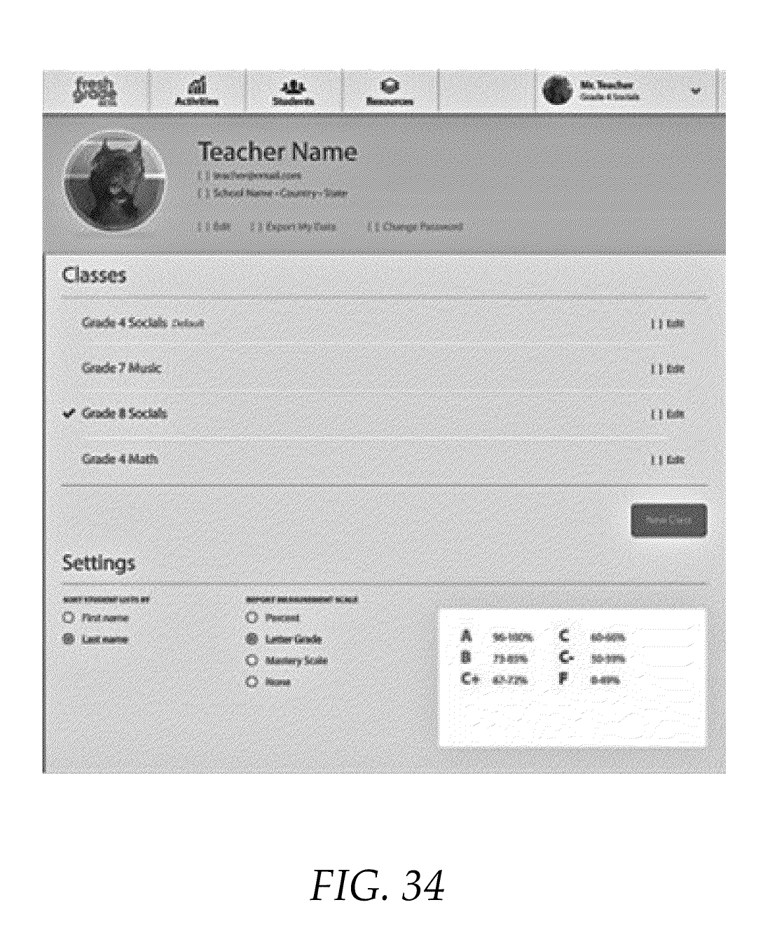

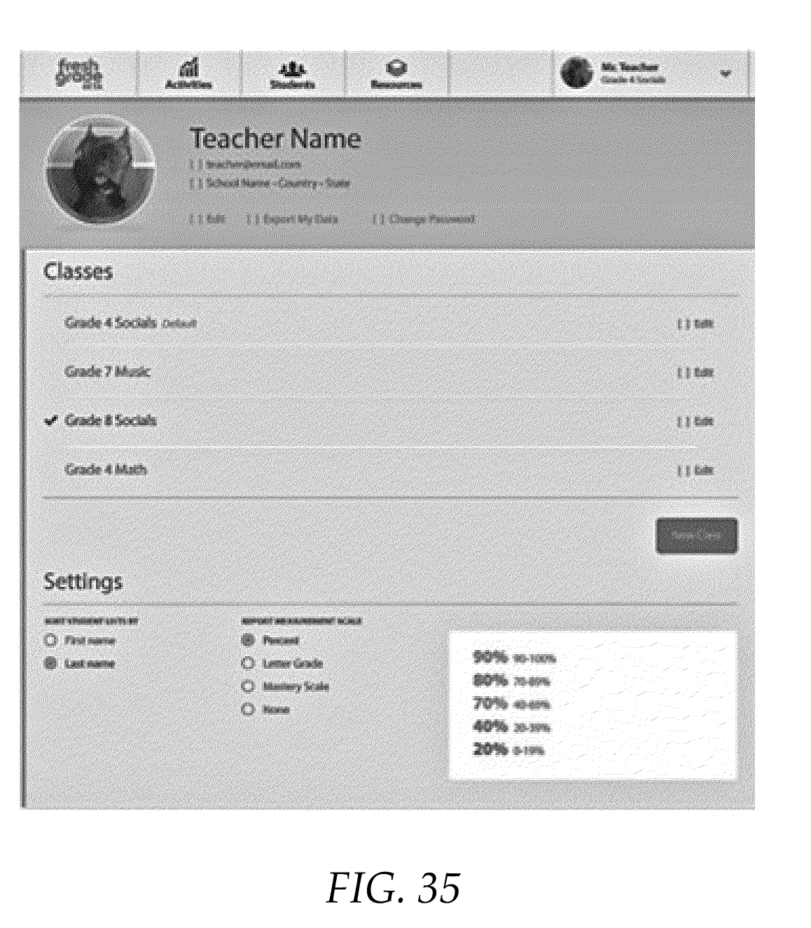

Examples of smart guides and other GUIs that are generated by the server 105 are illustrated and described with reference to FIGS. 2-35. The following flowcharts of FIGS. 1B-D are illustrative of example methods that can be executed by the server 105.

FIG. 1B is a flowchart of an example method for providing an individualized learning resource to a student. More specifically, but not by limitation, the method includes providing a teacher with means for creating a teacher smart guide that can be shared with a student or parent. The method also comprises generating electronic communication from the teacher to the parent/student.

For context, the method of FIG. 1B is executed by the server 105 that is configured perform a step of executing 140 a web application to create a web-based graphical user interface associated with a teacher account.

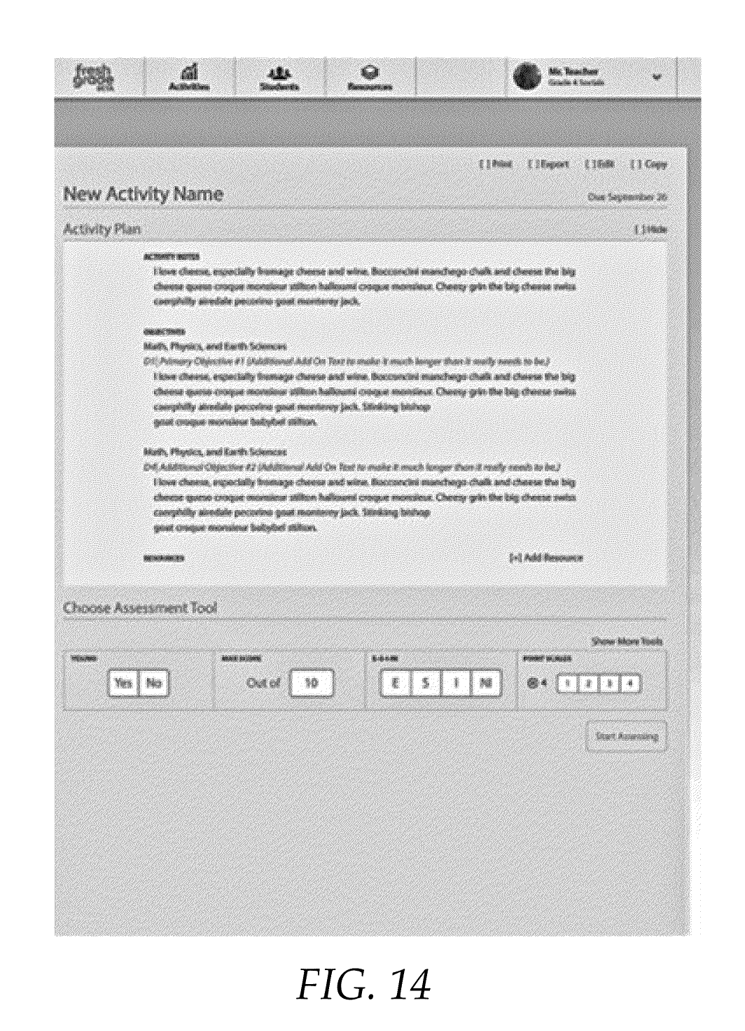

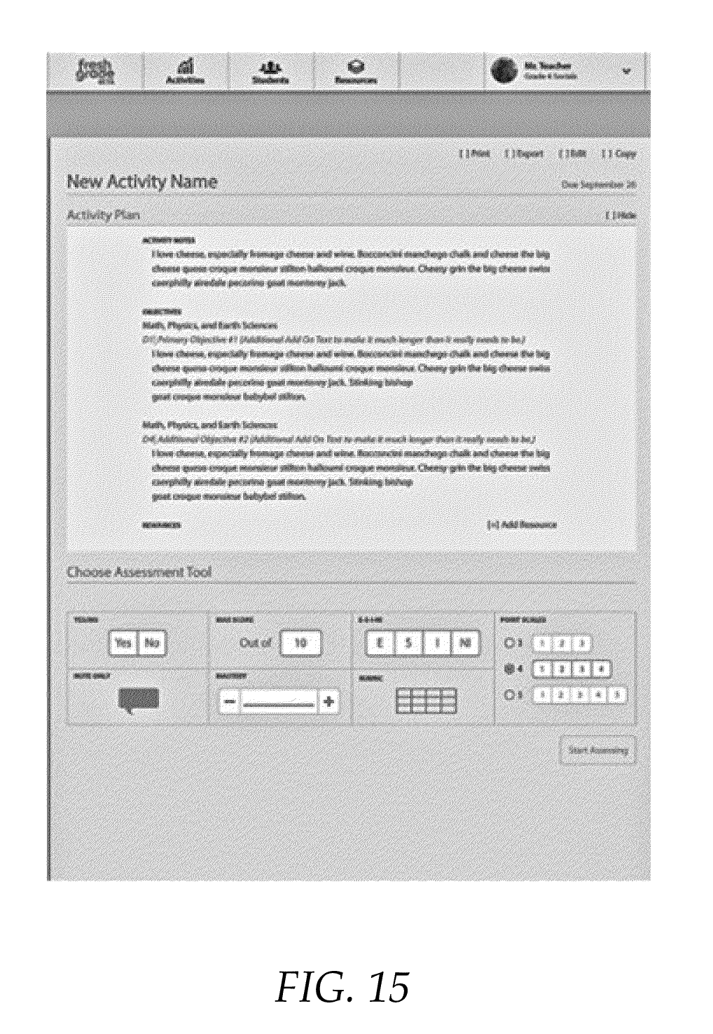

Next, the method comprises the server receiving 142 information transmitted by a teacher electronic device via the web-based graphical user interface. In some embodiments the information comprises at least one of a course curriculum, a lesson plan, a learning objective, an educational activity associated with a specific learning objective, and an evidence of learning by a student. FIGS. 14 and 15 collectively illustrate the creation of an educational activity by a teacher and the corresponding web interfaces used for creation of the same.

These interfaces in FIGS. 14 and 15 also illustrate selection of assessment tools that are linked to the educational activity. Thus, not only can the teacher select and define their educational activities, but also the teacher can define what assessments are applied to a student who is completing the activity. For example, the teacher can set a maximum score for the activity, select a grade/point scale, add notes, set an activity mastery scale. The teacher can also add a resource to the activity, such as a video or other media by clicking the plus sign. Clicking the plus sign causes the server 105 to connect with one or more third party resources 125. The server 105 can query the proper third party resources 125 based on knowledge of the educational activity. For example, the server 105 is instructed that the teacher has selected the creation of a mathematics activity. Thus, the server 105 can obtain resources from proper third party resources. The method includes the server 105 receiving 144 information transmitted by a teacher electronic device via the web-based graphical user interface, the information comprising at least one of a course curriculum, a lesson plan, a learning objective, an educational activity associated with a specific learning objective, and an evidence of learning by a student.

Next, the method includes the server 105 executing 146 an assessment algorithm, the assessment algorithm generating an assessment of a student progress on attaining the learning objective. The assessment algorithm is configured, in part, by the information input into by the teacher (as illustrated in FIGS. 14 and 15).

The method, in some embodiments, includes transmitting, from the server to the teacher electronic device, via the web-based graphical user interface certain types of information. While a wide variety of information can be transmitted, several types of information will be described in greater detail below. The web-based GUI can include any one or more of the following types of information. In one embodiment the information includes an assessment of the student progress on attaining the learning objective.

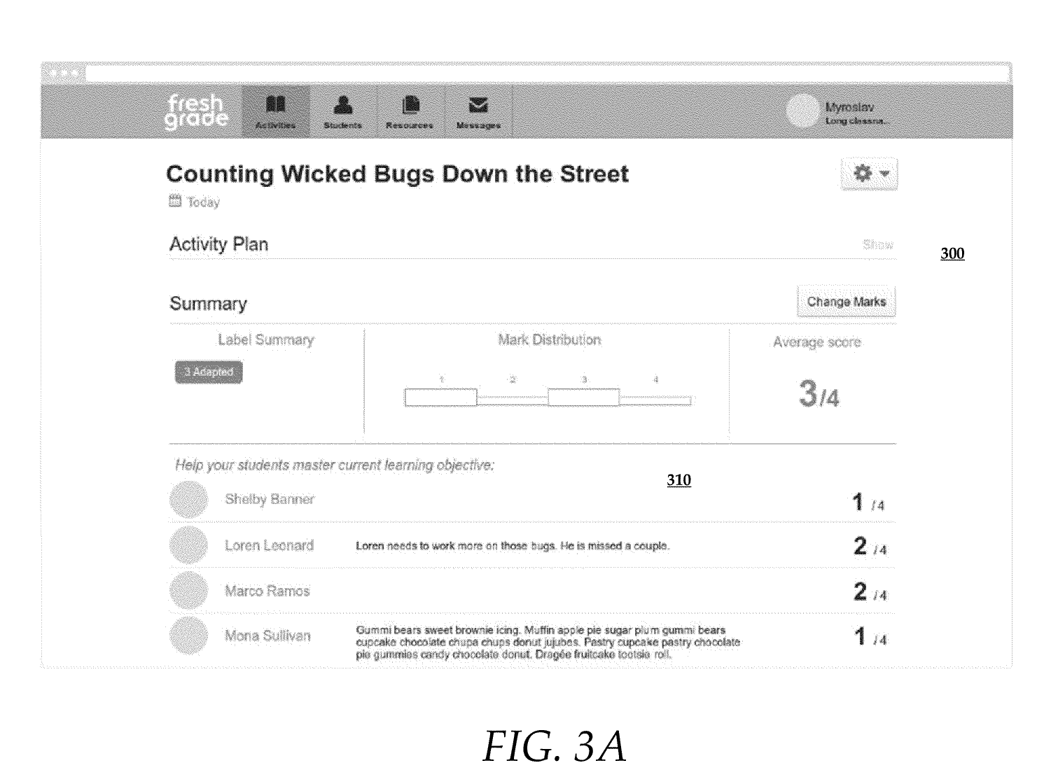

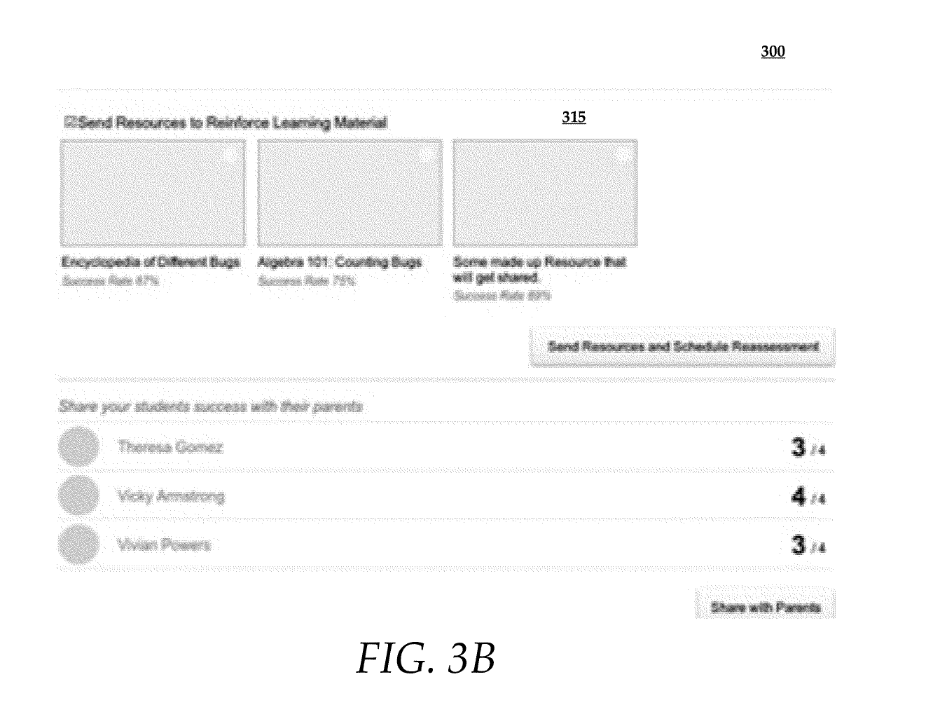

The teacher can use, for example, a teacher activity page 300 as illustrated in FIGS. 3A-B. The page 300 provides an overview of an activity plan as well as input mechanisms that allow the teacher to score a student on a given facet of the activity. The teacher can also select additional learning resources for the student and parent.

As the server 105 is receiving information from the teacher the server 105 can begin building and updating various reports that are presented to teachers, parents, students, and administrators—just to name a few.

Thus, in some embodiments, the method also includes enabling 148 an electronic communication between a teacher account and at least one of a student account and a parent account. The electronic communication is configured to enable the teacher to provide at least one of the student and the parent with at least one of an individualized feedback and a learning resource. The electronic communication could include a web page, a progress report, a report card, an email message, a learning objective summary, as well as other electronic communications described herein.

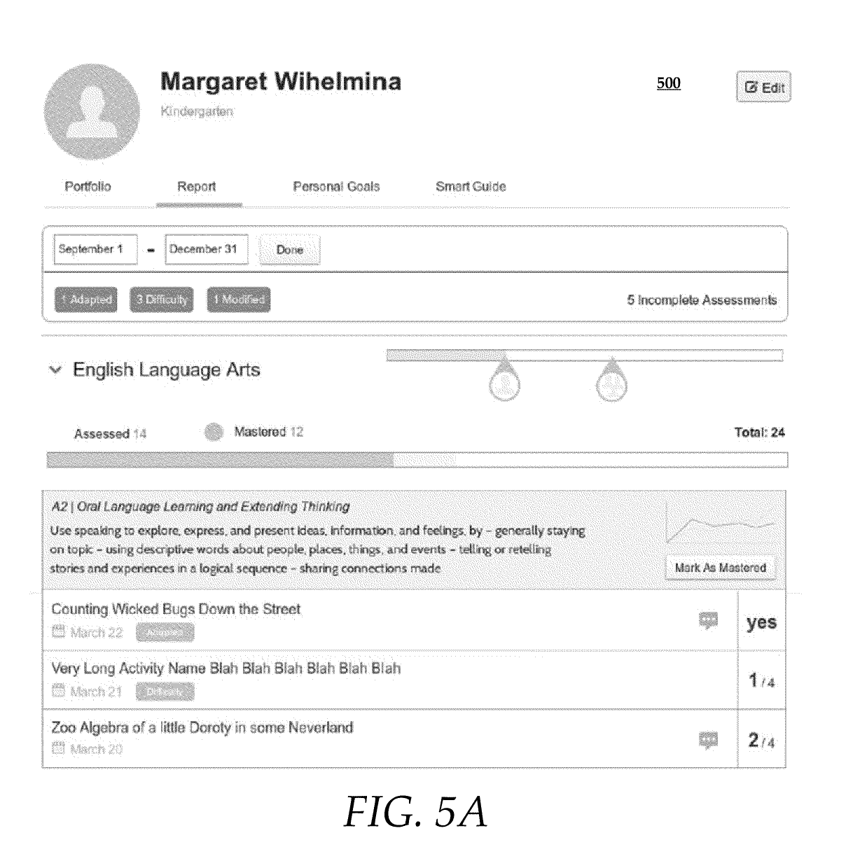

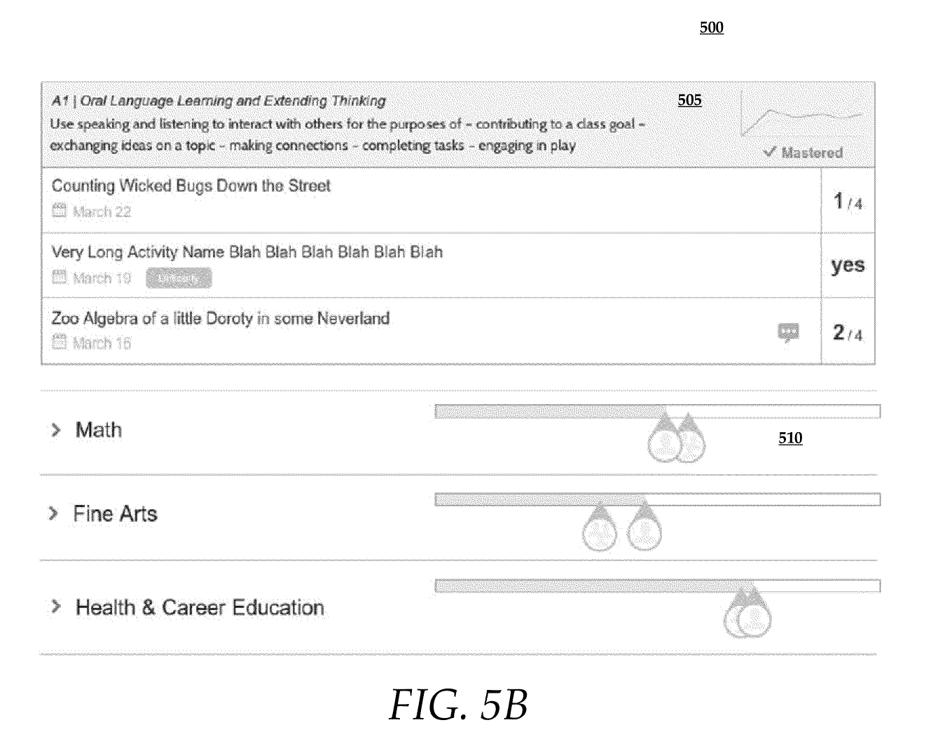

For example, FIGS. 5A-B collectively illustrate a student report interface 500 that is used to illustrate student information and educational progress. Additional details regarding FIGS. 5A-B will be described in greater detail below.

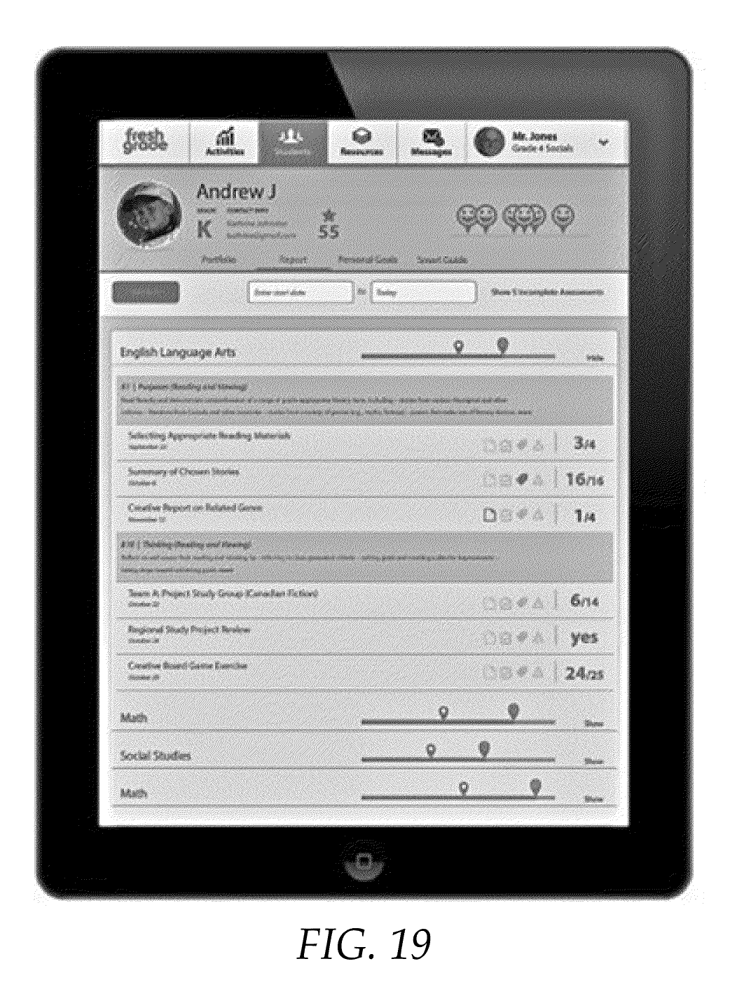

Additional example GUIs that illustrate student progress is FIGS. 19, 25, 27, 29, and 31.

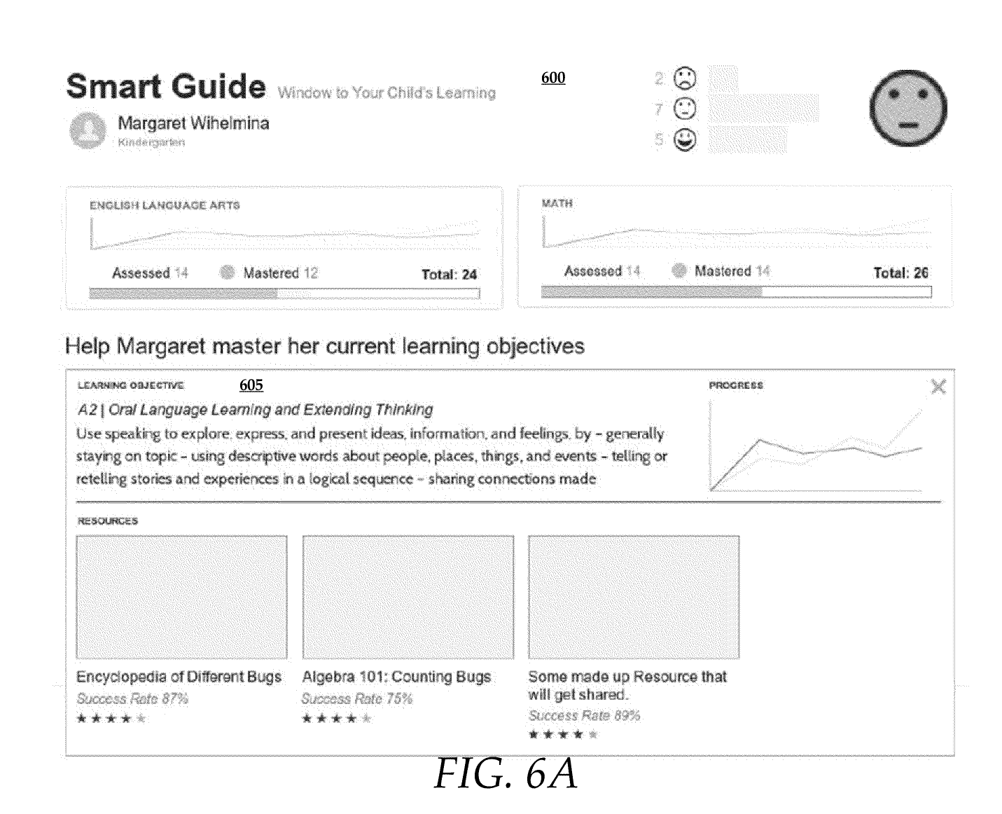

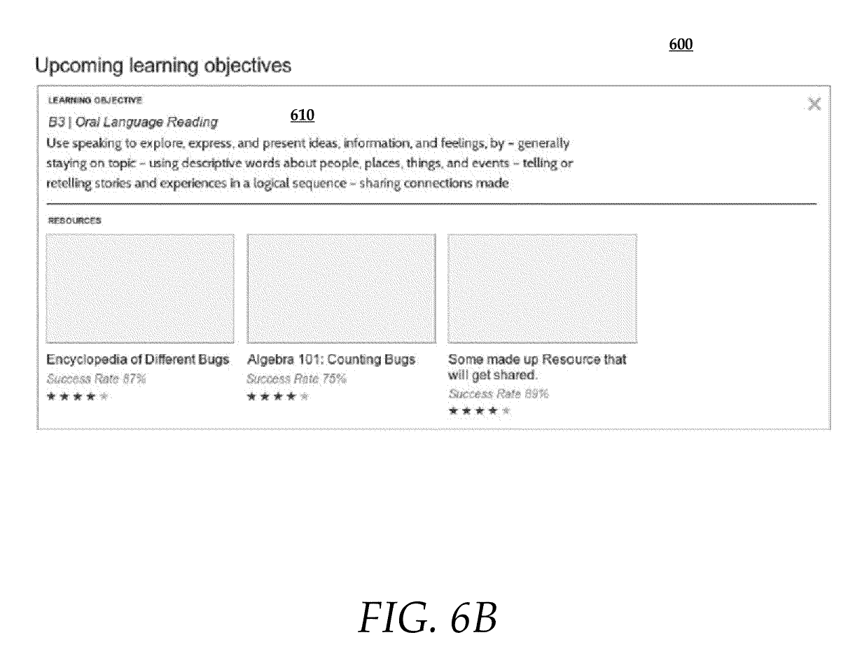

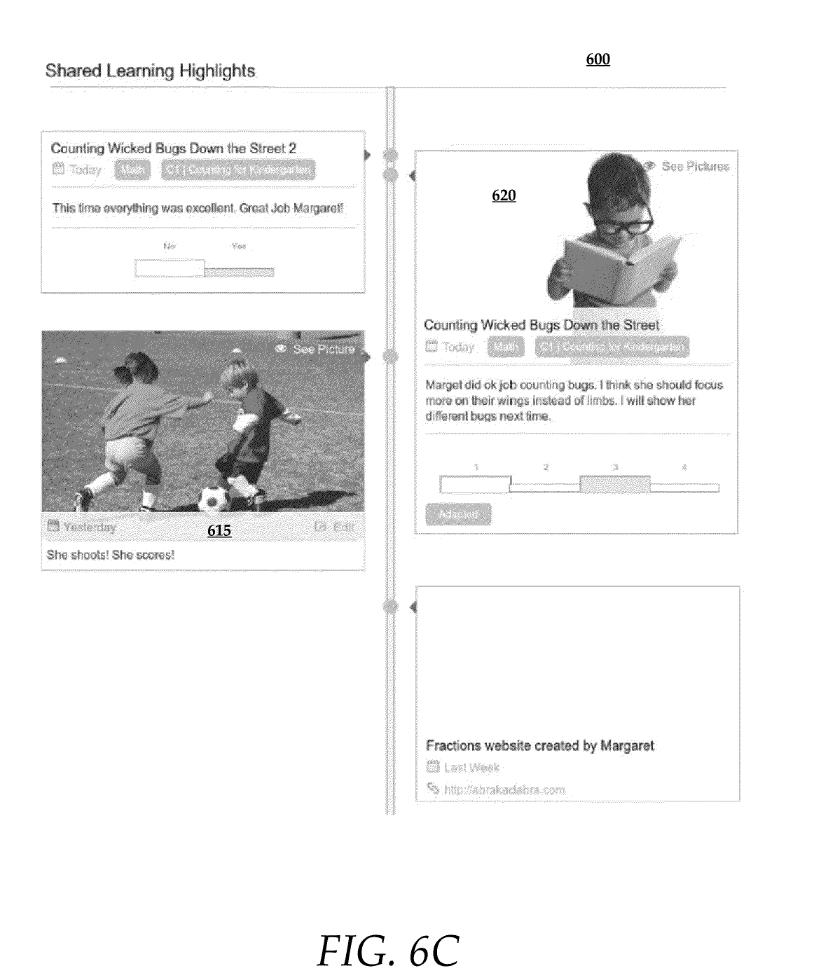

In another embodiment, the electronic communication includes an assessment of the student progress on attaining the learning objective. In yet another embodiment, the information transmitted comprises a suggestion, based on the assessment of a student progress, to the teacher of an individualized learning resource from a resource database that could assist the student in attaining the learning objective. For example, FIG. 6A-C collectively illustrate a parent smart guide 600 that comprises various suggestions for the parent that will aid the student in improving their progress in one or more areas related to a learning objective.

In some embodiments, the electronic communication could comprise an electronic communication from the student and a parent of the student. For example, the parent smart guide 600 in FIGS. 6A-C include notes or messages from the teacher to the parent of a student that provide the parent with feedback about the behavior or activities of the student at school. The message could also include an email message or SMS message from the teacher to the end user device of the parent, such as a cellular telephone.

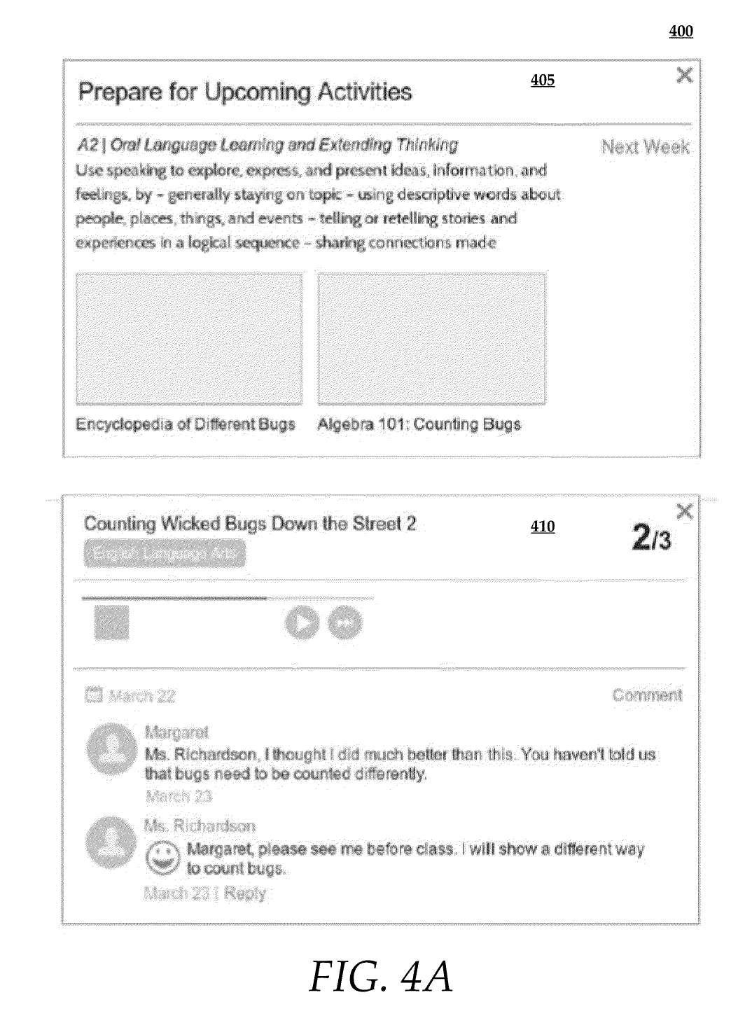

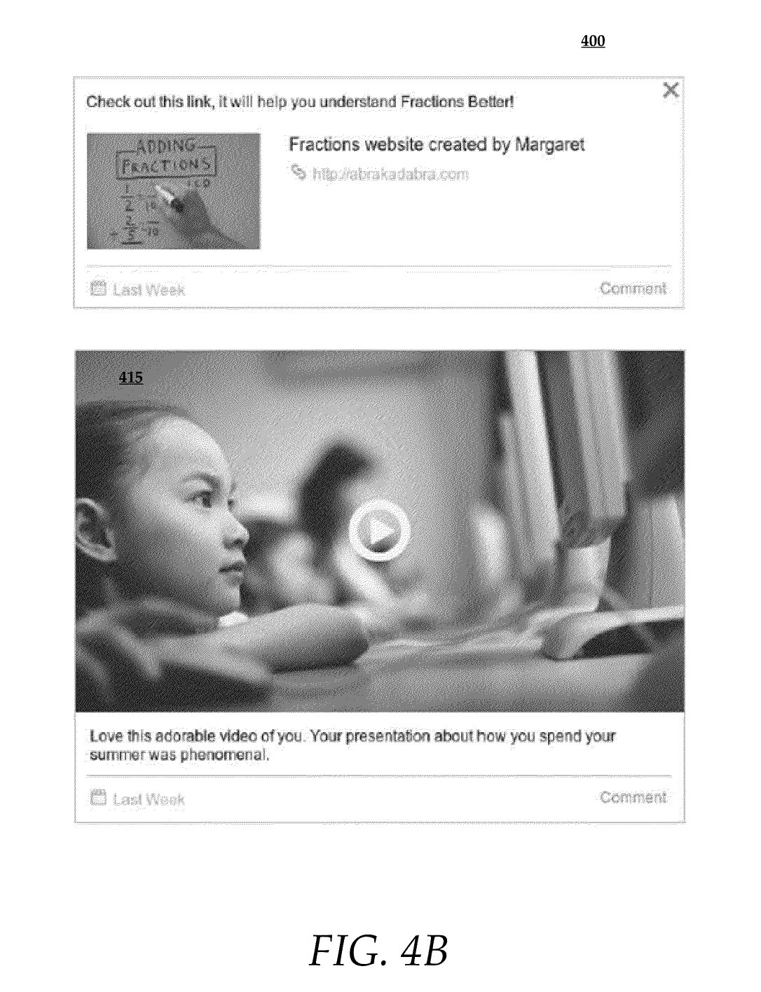

In another embodiment, the electronic communication comprises a student smart guide 400 as illustrated in FIGS. 4A-B.

In yet another embodiment, the electronic communication comprises a teacher smart guide 200 as illustrated in FIGS. 2A-B. The teacher smart guide 200 includes an overview for their class regarding class performance with respect to one or more activities. Class/student progress is illustrated in various graphical formats. Additional details regarding the teacher smart guide 200 will be described in greater detail below.

FIG. 1C is a flowchart of an example method for providing an individualized learning resource to a student. In some embodiments, the method comprises a step of creating 150 a web-based graphical user interface associated with a student account. For example, FIG. 4 illustrates a student smart guide 400. This guide can be linked to a student account that includes information about the student such as name, grade, address, teacher identification, school location or other information, subjects, as well as other information described herein as being displayed on, or used to create a student smart guide.

Next, the method includes transmitting 152, from the server to a student electronic device via the web-based graphical user interface, information. Generally, this includes the student providing information to the server 105 using their smart guide. For example, the student can perform work included in the smart guide, view resources included in their smart guide, as well as utilize other inputs that are illustrated or described with respect to student smart guides. In one example, the student can provide feedback on a learning objective or a message from their teacher. In another embodiment, the student can complete quizzes or tests that are electronic in nature and linked to the student account/smart guide.

In another embodiment, the information comprises an assessment of a student learning progress in an academic subject or in relation to a learning objective. The information can also comprise an individualized learning resource from a resource database that assists the student in mastering the academic subject or the learning objective. In yet another embodiment, the information can comprise an individualized learning resource from a resource database that assists the student in preparing for an upcoming educational activity or lesson, as well as a homework assignment assigned by a teacher. In some embodiments, the information comprises an electronic communication from the teacher, the electronic communication including a feedback on a student learning progress provided by the teacher.

As mentioned above, any combination or permutation of information types described can be included.

According to some embodiments, the method comprises receiving 154 information transmitted by the student electronic device via the web-based graphical user interface. The information comprises at least one of (or any combination of) homework and an activity completed by the student, a document, a video or audio file, or other evidence of learning created by the student.

In accordance with the present technology, the method can also comprise enabling 156 electronic communication between the student account and a teacher account. The electronic communications are configured to enable the student to provide the teacher with a feedback and to ask the teacher a question.

In addition to creating various smart guides, the present technology can be applied to generate information rich student evaluations such as progress reports and report cards. Rather than representing the student's progress using obtuse information such as grades, the student evaluations of the present technology can include more granular information that allows the student and/or parent to glean more detailed information about the student's performance and progress through subjects, as well as learning objectives in each subject/activity.

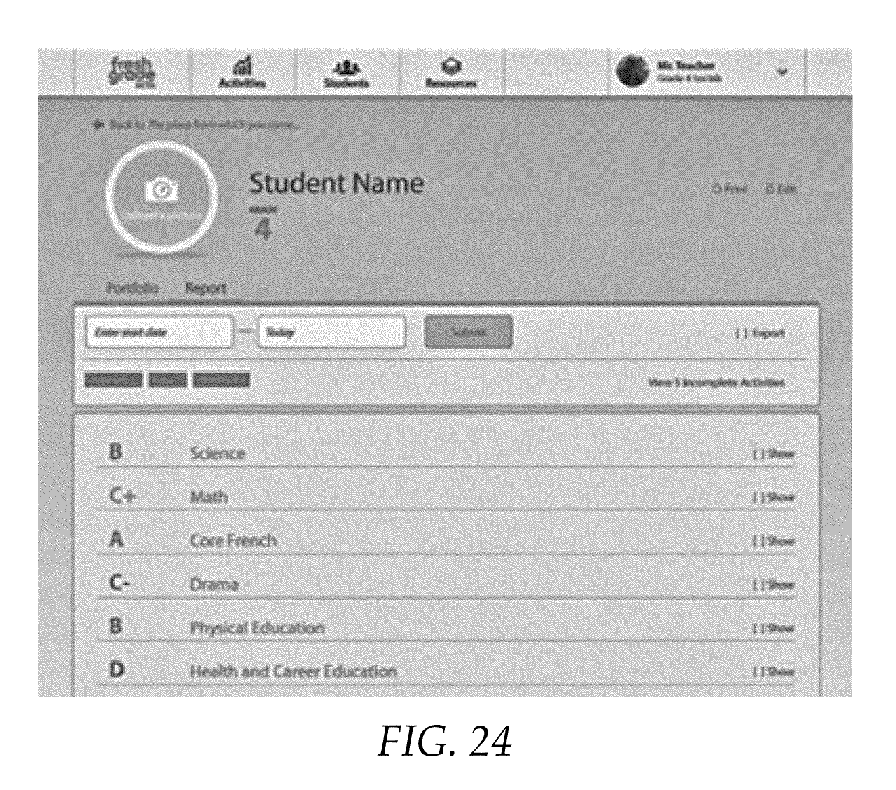

By way of example, a report card uses a letter grade to represent the performance of a student in a given subject. For example, a student receives a B in mathematics. The present technology allows the teacher to collect evidence of learning throughout a semester (or other period of time), even on an activity-by-activity or objective-by-objective basis. Feedback on the performance of the student is collected periodically or on an as-needed basis (e.g., daily, per activity, weekly, etc.). This evidence of learning can be populated into a student evaluation as illustrated in FIGS. 24-31.

Thus, in some embodiments, the present technology can comprise a method executed by the server 105, as illustrated in the method of FIG. 1D. The method comprises providing an electronic report card for a student. The method comprises executing 160 a web application, the web application creating a web-based graphical user interface associated with a parent account.

Next, the method comprises transmitting 162, from the server to a parent electronic device via the web-based graphical user interface in the form of a report card, the report card comprising a selectable list of subjects, each of the subjects being associated with a grade, wherein selection of a subject of the list causes the display of learning objectives for the student, each of the learning objectives having an indication of whether the student completed or failed, wherein selection of a failed objective causes the display of teacher feedback that describes why the student failed at the learning objective.

FIGS. 2A and 2B are collectively a screen shot of one embodiment of a web-based graphical user interface that can be accessed by a teacher. More specifically, FIGS. 2A and 2B are a screen shot of a teacher dashboard. In one embodiment, the teacher dashboard is the homepage of the teacher's Smart Guide. On the teacher dashboard, the teacher can visualize the performance of the entire class in each academic subject. The teacher dashboard also provides the teacher with other useful information, such as the number of students in the class who have not yet mastered each learning objective, identifies individual students who are experiencing difficulty mastering each learning objective, and recommends individualized learning resources that the teacher could send to each student to assist them in mastering each learning objective. As illustrated in FIGS. 2A and 2B, the Smart Guide also identifies students who have made significant progress and suggests that the teacher reward the student with positive feedback.

In one embodiment, the interface comprises a class performance class performance graph 205 that comprises, for each of a plurality of students, the assessment of the student progress on attaining the learning objective.

In furtherance of displaying information relating to the students, the server 105 is configured to measure which of the plurality of students is not properly progressing based on the assessment. In some embodiments, the suggestion is displayed in a suggestion feed 210.

FIGS. 3A and 3B are collectively a screen shot of one embodiment of the teacher activity page. In this embodiment, the Smart Guide allows teachers to create learning activities for students. Student performance on these activities is assessed, and the teacher can add learning resources to reinforce the learning material that is being tested by the activity. The Smart Guide can also suggest learning resources based on the assessment of each student's progress or performance on the learning activity.

In accordance with the present technology, the server 105 is also configured to track progress of each of the plurality of students relative to the learning objective. In some embodiments, the server 105 tracks an identification of a student of the plurality of students that have made achievements towards achieving the learning objective. In another embodiment, the server tracks an identification of a student of the plurality of students that are failing to make achievements towards achieving the learning objective.

To be sure, the identification sets forth facets of the learning objective with which the student is struggling. These students are illustrated in section 310.

In some embodiments, the evidence of learning by a student comprises a count of the learning objective for a student. For example, count relates to how many learning objectives have been passed or failed by the student.

As mentioned above, the server 105 can provide suggestions to the teacher that can be passed to the parent which aids the student with respect to a learning objective. The suggestion can include study materials that are added to a reinforcement section 315 of an activity plan, by the teacher or the server.

In one embodiment, the study materials are also provided in the electronic communication to the parent account. In some instances, a link to the resource is provided, or the materials can be provided directly in the message.

In some embodiments, the web-based graphical user interface further comprises an assignment reporting module that identifies incomplete assignments over a given period of time.

The UI also includes a progress indicator (see FIG. 1) for a class.

FIGS. 4A and 4B collectively are a screen shot of one embodiment of a web-based graphical user interface that can be accessed by a student. More specifically, FIGS. 4A and 4B are collectively a screen shot of the student's Smart Guide homepage. In this embodiment, the Smart Guide provides the student with learning resources that will help them prepare for upcoming activities. The student's homepage may also include video and audio recordings, photographs, websites, documents, and other evidence of learning created and/or uploaded by the student and/or captured and uploaded by the teacher for the student.

The student smart guide comprises a list of upcoming activities 405 for the student, as well as a current learning objective module 410 for the student, wherein the student can provide feedback commentary to the teacher in the current learning objective module.

The smart guide can include media 415 for the student that has been uploaded by the teacher.

FIGS. 5A and 5B are collectively a screen shot of one embodiment of the student report. The student report shows the student's progress and performance in relation to the student's class. The report also shows the number of activities the student has mastered relative to the number of activities for which the student has been assessed. As explained above, rather than focusing on an absolute measure of performance, such as a letter grade, the student report focuses on the student's progress or improvement in each subject or in relation to each learning objective.

In another embodiment, the web-based graphical user interface further comprises an identification of learning objectives that have been assessed by the server and an indication of which of the learning objectives have been mastered by the student, as in section 505.

According to some embodiments, the web-based graphical user interface further comprises a progress bar 510 that includes a progress indicator that represents the student learning progress in an academic subject or in relation to a learning objective.

FIG. 6A-C are collectively screen shot of one embodiment of a web-based graphical user interface that can be accessed by a parent. More specifically, FIGS. 6A-6B are a screen shot of one embodiment of the parent's Smart Guide. As FIG. 6 illustrates, in this embodiment, the Smart Guide shows the parent his or her child's progress in each academic subject and in relation to each learning objective. The Smart Guide also recommends to the parent learning resources that could help his or her child attain various learning objectives. In one embodiment, the Smart Guide has the capacity to rate the effectiveness of each learning objective. The parent is also able to access teacher feedback through the Smart Guide and view his or her child's portfolio of video and audio recordings, documents, notes, and other evidence of learning created and/or uploaded by the student and/or captured and uploaded by the student's teacher.

In one embodiment, the parent smart guide further comprises one or more learning objective modules 605 for a student account linked to the parent account. The one or more learning objective modules are configured to define the student's progress with respect to a learning objective. The learning objective module 605 includes current learning objectives that the student is working on.

The parent smart guide can also further comprise a learning objective associated with the individualized learning resource that was selected for the student. For example, the Encyclopedia of Different Bugs is a resource selected for the learning objective Oral Language Learning and Extending Thinking.

In some embodiments, the parent smart guide can also further comprise a list of upcoming activities 610 for the student account that is linked to the parent account.

As mentioned above, the teacher can place items such as a document, a video or audio file, and other evidence of learning for the student in the parent smart guide. In some embodiments, these items can further comprise media 615 associated with a sports or academic activity of the student.

In one embodiment, the feedback on the student learning progress provided by the teacher further comprises a personalized message 620 from the teacher account to the parent account relative to the student's progress with respect to the academic subject or the learning objective.

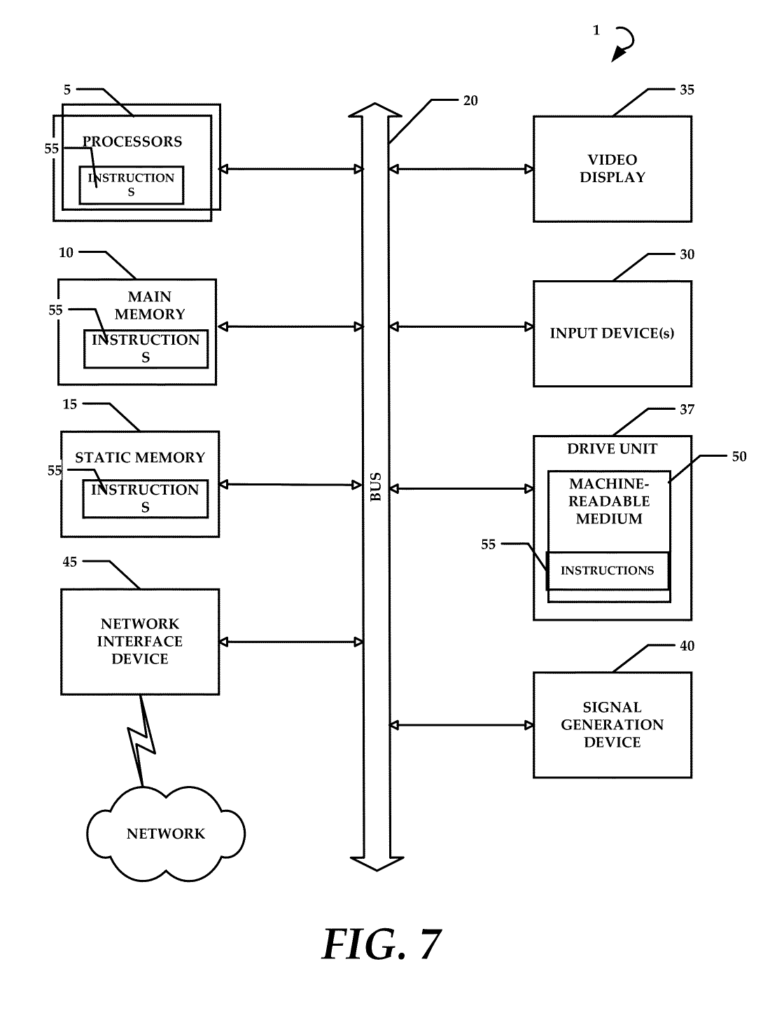

FIG. 7 shows a diagrammatic representation of a machine in the example electronic form of a computer system, within which a set of instructions for causing the machine to perform anyone or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform anyone or more of the methodologies discussed herein.

The example computer system includes a processor or multiple processors (e.g., a central processing unit (CPU), a graphics processing unit (GPU), or both), a main memory and a static memory, which communicate with each other via a bus. The computer system may further include a video display unit (e.g., a liquid crystal display (LCD) or a cathode ray tube (CRT)).

The computer system may also include an alphanumeric input device (e.g., a keyboard), a cursor control device (e.g., a mouse), a disk drive unit, a signal generation device (e.g., a speaker), and a network interface device.

The disk drive unit includes a non-transitory computer-readable medium, on which is stored one or more sets of instructions and data structures (e.g., instructions) embodying or utilized by any one or more of the methodologies or functions described herein. The instructions may also reside, completely or at least partially, within the main memory and/or within the processors during execution thereof by the computer system. The main memory and the processors may also constitute machine-readable media. The instructions may further be transmitted or received over a network via the network interface device utilizing anyone of a number of well-known transfer protocols (e.g., Hyper Text Transfer Protocol (HTTP)).

While the computer-readable medium is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform anyone or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for providing a network proxy layer are disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

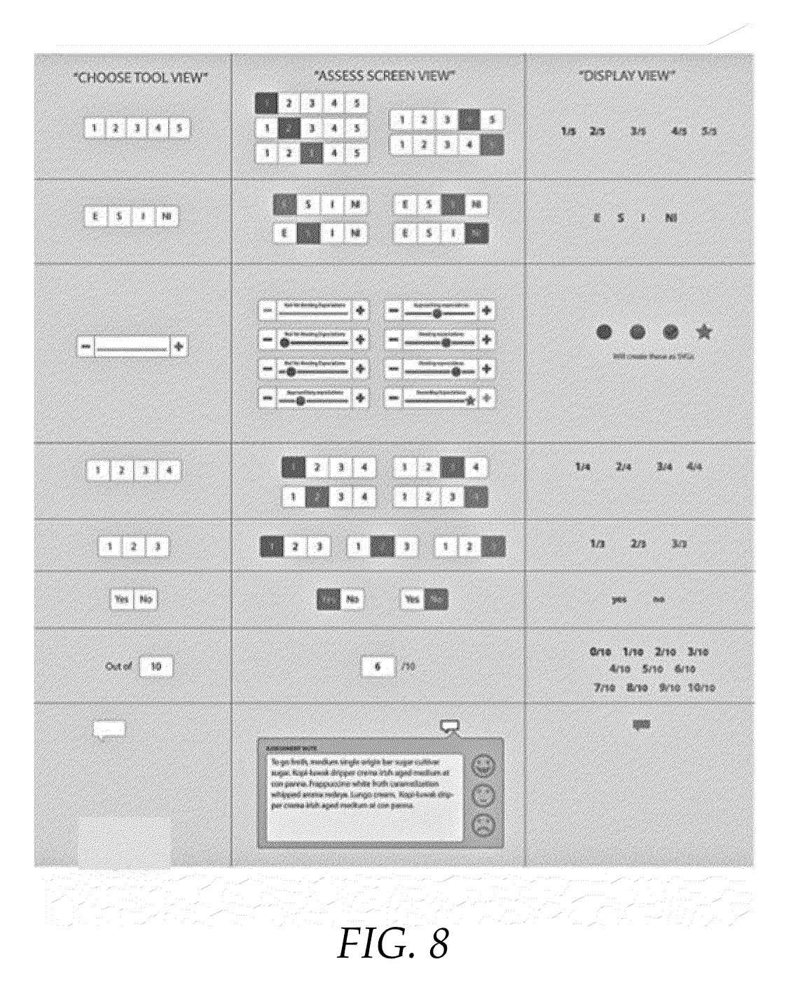

FIG. 8 illustrates one embodiment of various assessment tools. These assessment tools are used to assess a student's progress in mastering a learning objective or an academic subject. An assessment algorithm may be created by using a combination of these assessment tools. The assessment algorithm can be used to determine the extent of a student's learning progression. An assessment of a student's learning progress focuses on the student's improvement rather than his or her absolute performance on a given subject or activity.

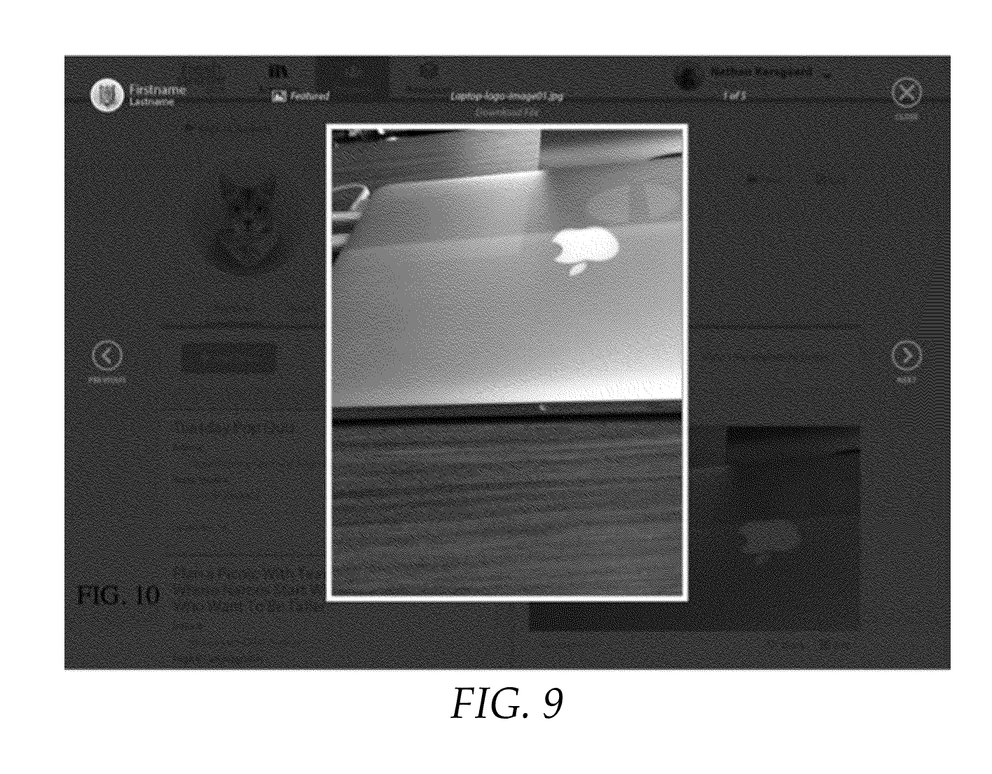

FIGS. 9-13 illustrate the placement and use of media in an activity plan for a student.

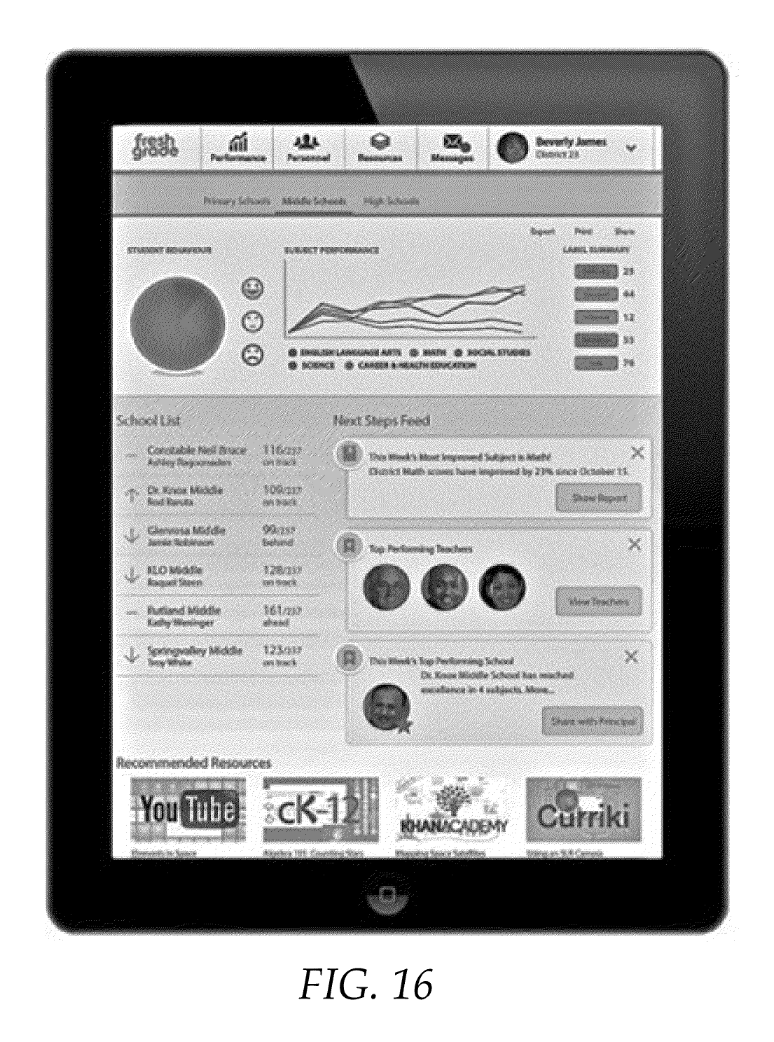

FIG. 16 is a screen shot of an administrator smart guide that illustrates the performance of students at the middle school grade levels and graphically illustrates student progress over time in a variety of subjects.

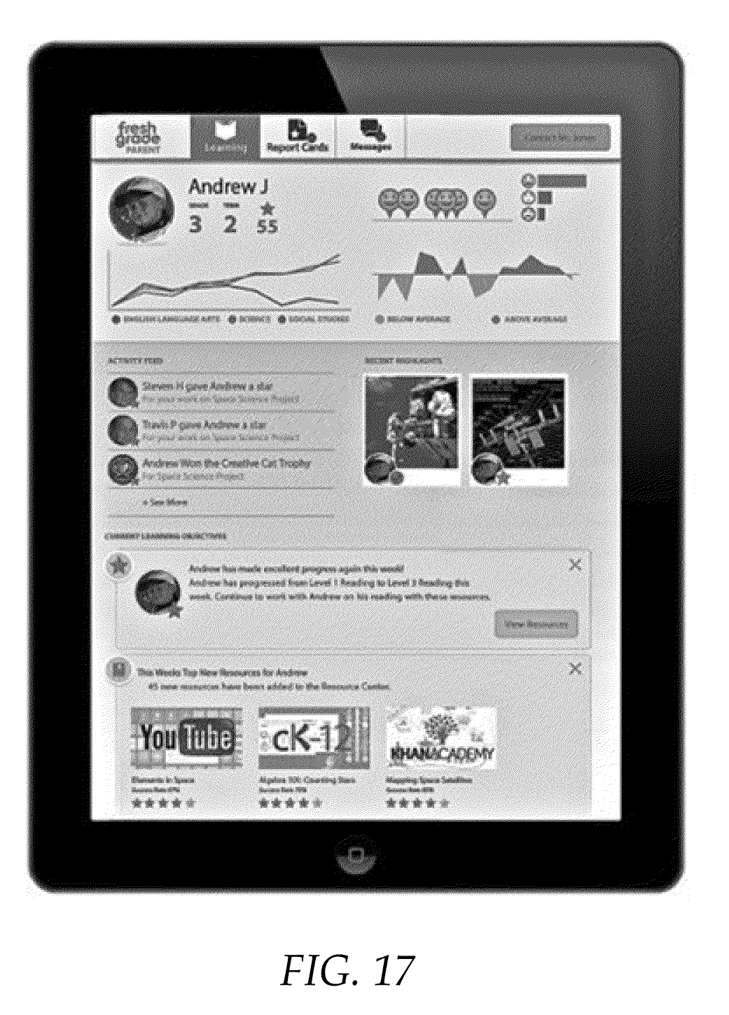

FIG. 17 is a screen shot of a student profile that illustrates the progress of the student over time with respect to various subjects. An activity feed includes feedback from teachers and students for the subject student. Current learning objectives are displayed as well as resources.

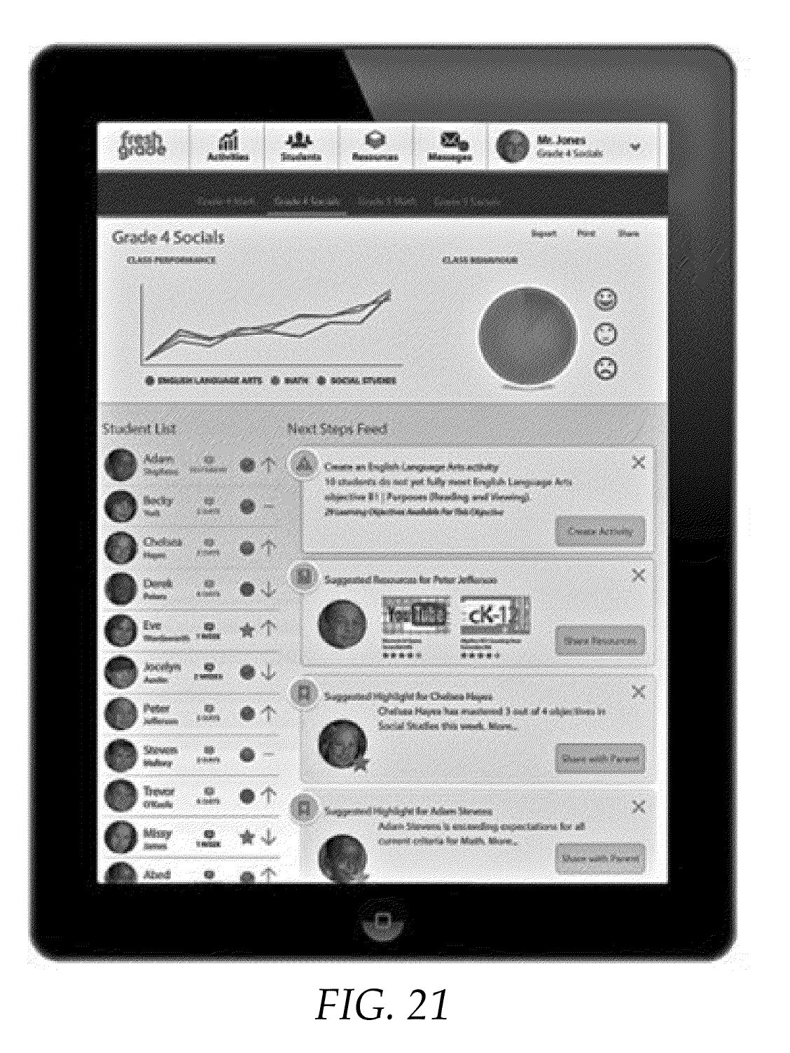

FIG. 21 illustrates the performance of an entire grade of students, for example fourth grade students. A graphical illustration of student progress is provided as well as a next steps feed which helps teachers and administrators prepare for promoting student learning.

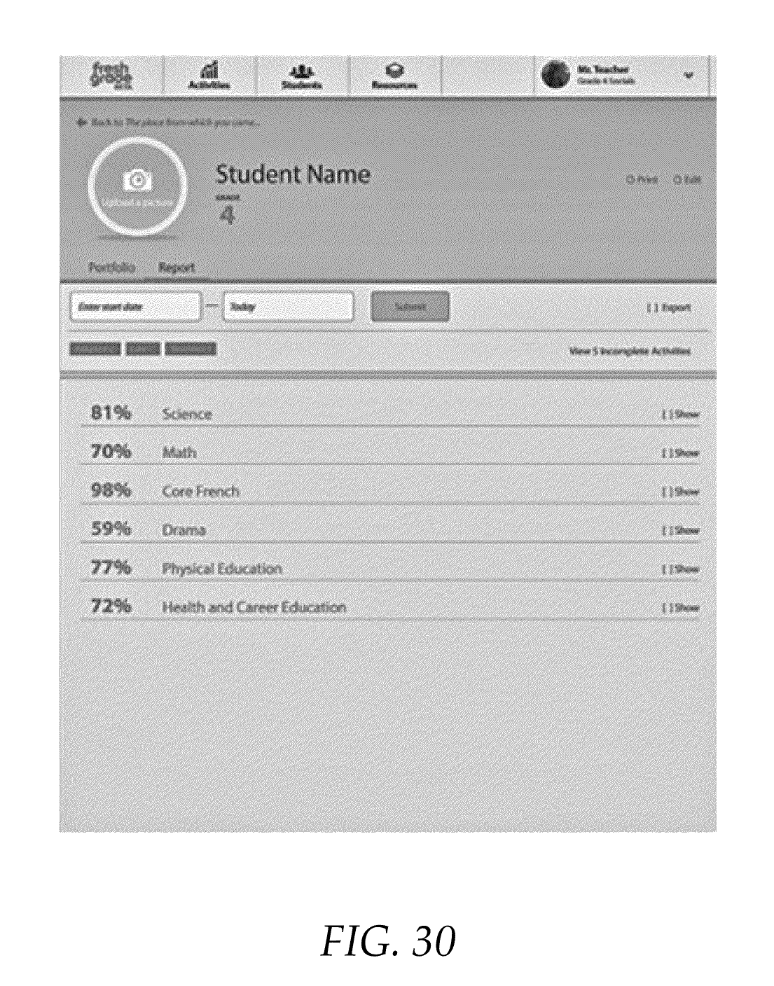

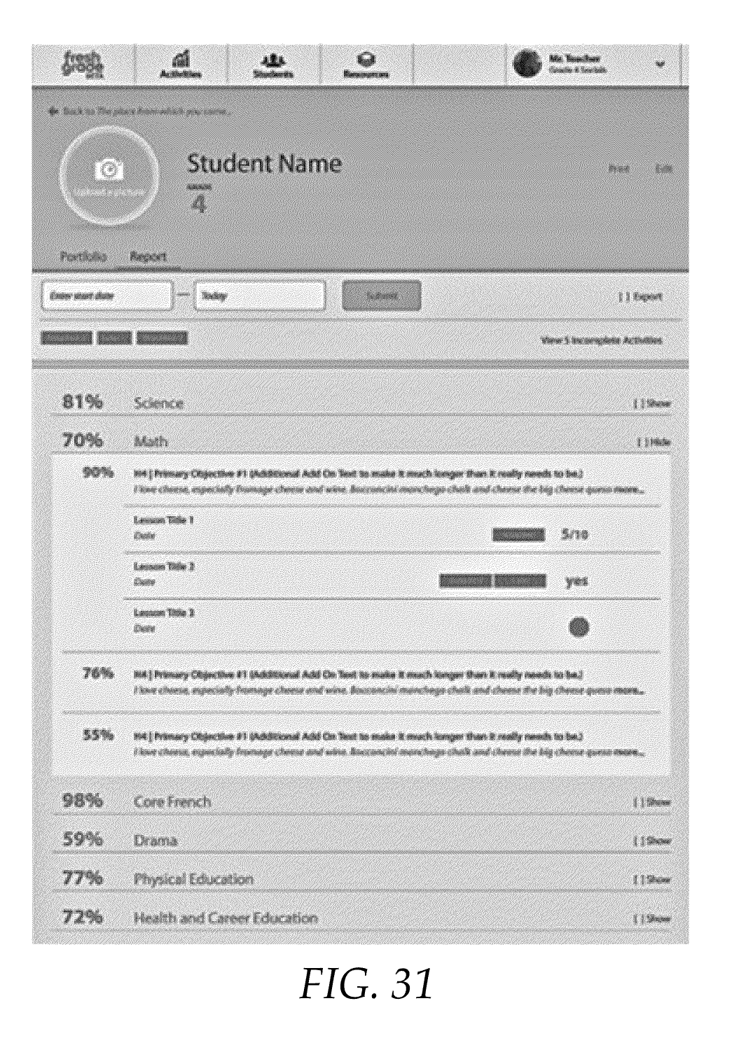

FIGS. 24-31 illustrate various examples of UIs in the form of student evaluations such as report cards. For example, the UIs in FIGS. 30 and 31 include a selectable list of subjects 3100, each of the subjects being associated with a grade. Selection of a subject of the list causes the display of learning objectives 3105 for the student. Each of the learning objectives is provided with an indication of whether the student completed or failed.

In some embodiments, selection of a failed objective causes the display of teacher feedback that describes why the student failed at the learning objective.

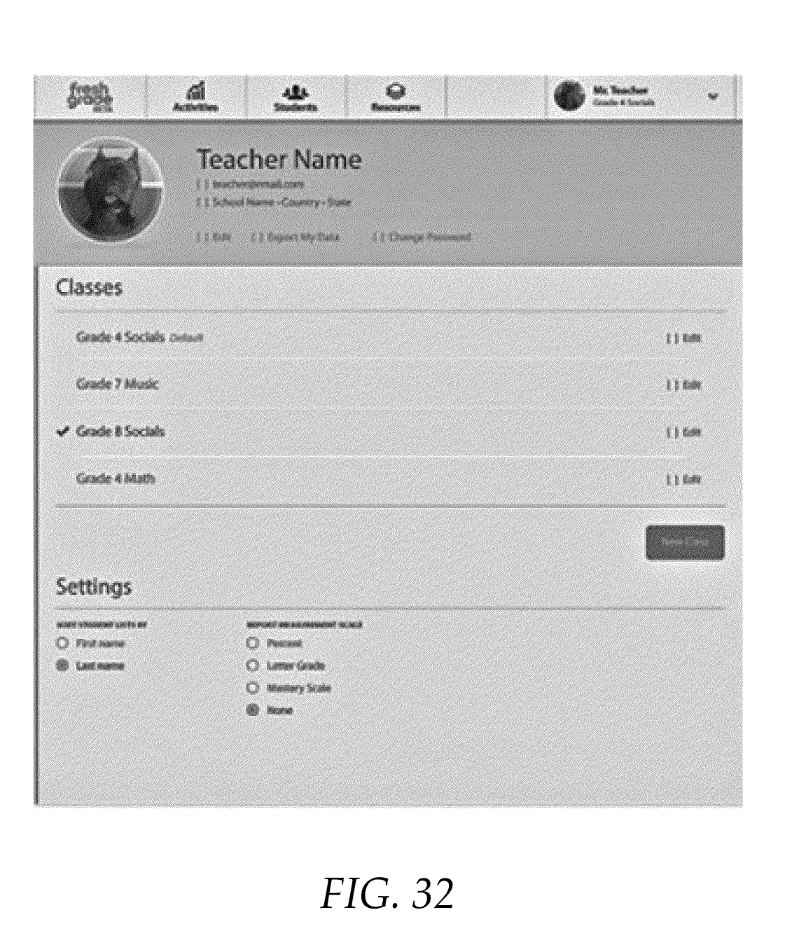

FIGS. 32-35 each illustrate a teacher profile page that can include information about which subjects the teacher is facilitating, as well as a settings module that allows the teacher to select how reports are formatted and how grades are displayed (e.g., a selectable measurement scale). For example, the teacher can specify whether letter grades are included or not. The teacher can also select to have a learning objective mastery scale included in the report.

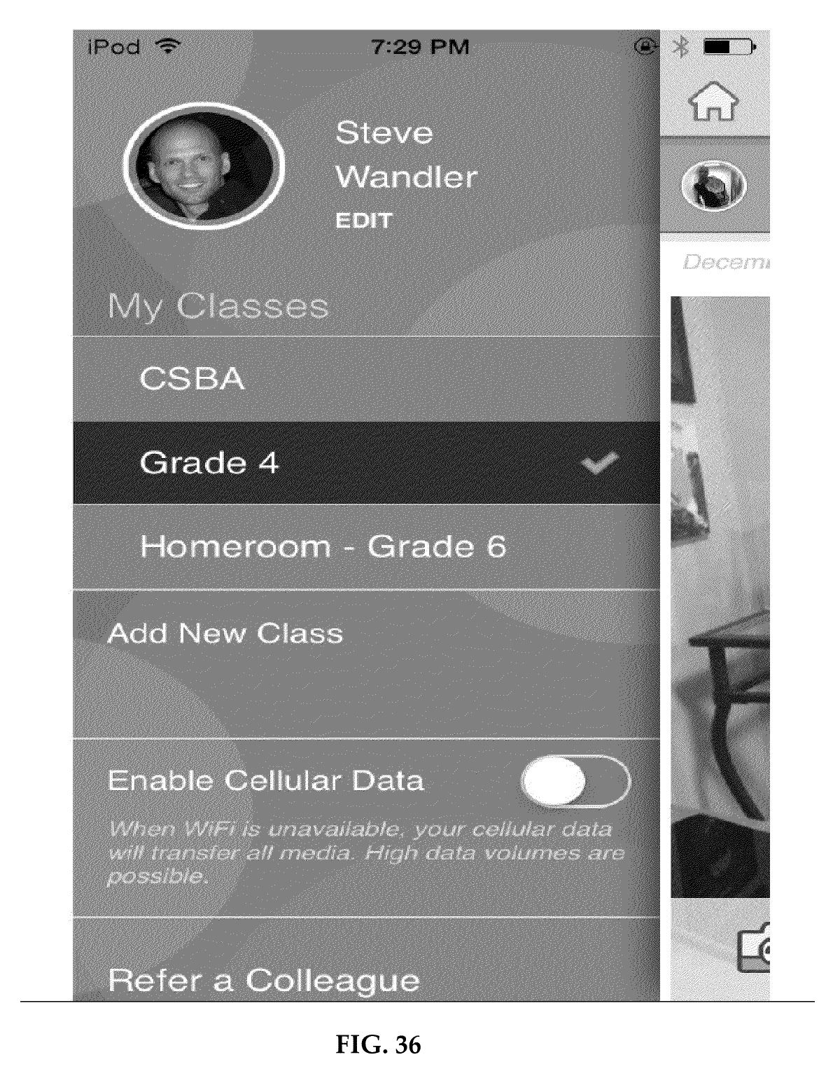

FIG. 36 is a screen shot of one embodiment of a teacher mobile application.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for providing an individualized learning resource to a student, the method comprising:
executing, by a server, a web application, the web application creating a web-based graphical user interface associated with a teacher account;
receiving, by the server, information transmitted by a teacher electronic device via the web-based graphical user interface, the information comprising at least one of a course curriculum, a lesson plan, a learning objective, an educational activity associated with a specific learning objective, and an evidence of learning by a student;
executing, by the server, an assessment algorithm, the assessment algorithm generating an assessment of a student progress on attaining the learning objective;
transmitting, from the server to the teacher electronic device via the web-based graphical user interface, information comprising:
the assessment of the student progress on attaining the learning objective;
a suggestion, based on the assessment of a student progress, to the teacher of an individualized learning resource from a resource database that could assist the student in attaining the learning objective; and
an electronic communication from the student and a parent of the student; and
enabling, by the server, an electronic communication between a teacher account and at least one of a student account and a parent account, the electronic communication enabling the teacher to provide at least one of the student and the parent with at least one of an individualized feedback and a learning resource.

2. The method according to claim 1, wherein the information further comprises a class performance graph that comprises, for each of a plurality of students, the assessment of the student progress on attaining the learning objective.

3. The method according to claim 2, wherein the server is configured to measure which of the plurality of students is not properly progressing based on the assessment, wherein the suggestion is displayed in a suggestion feed.

4. The method according to claim 2, further comprising tracking progress of each of the plurality of students relative to the learning objective, wherein the information further comprises:
an identification of a student of the plurality of students that have made achievements towards achieving the learning objective; and
an identification of a student of the plurality of students that are failing to make achievements towards achieving the learning objective, the identification setting forth facets of the learning objective with which the student is struggling.

5. The method according to claim 1, wherein the evidence of learning by a student comprises a count of the learning objective for a student.

6. The method according to claim 1, wherein the suggestion includes study materials that are added to a reinforcement section of an activity plan, by the teacher or the server.

7. The method according to claim 6, wherein the study materials are also provided in the electronic communication to the parent account.

8. A method for providing an individualized learning resource to a student, the method comprising:
executing, by a server, a web application, the web application creating a web-based graphical user interface associated with a student account;
transmitting, from the server to a student electronic device via the web-based graphical user interface, information comprising:
an assessment of a student learning progress in an academic subject or in relation to a learning objective;
an individualized learning resource from a resource database that assists the student in mastering the academic subject or the learning objective;
an individualized learning resource from a resource database that assists the student in preparing for an upcoming educational activity or lesson;
a homework assignment assigned by a teacher;
an electronic communication from the teacher, the electronic communication including a feedback on a student learning progress provided by the teacher;
receiving, by the server, information transmitted by the student electronic device via the web-based graphical user interface, the information comprising at least one of a homework and an activity completed by the student, a document, a video or audio file, or other evidence of learning created by the student; and
enabling, by the server, electronic communication between the student account and a teacher account, the electronic communication enabling the student to provide the teacher with a feedback and to ask the teacher a question.

9. The method according to claim 8, wherein the web-based graphical user interface further comprises an assignment reporting module that identifies incomplete assignments over a given period of time.

10. The method according to claim 8, wherein the web-based graphical user interface further comprises an identification of learning objectives that have been assessed by the server and an indication of which of the learning objectives have been mastered by the student.

11. The method according to claim 8, wherein the web-based graphical user interface further comprises a progress bar that includes a progress indicator that represents the student learning progress in an academic subject or in relation to a learning objective, as well as a progress indicator for a class, wherein the student is included in the class.

12. The method according to claim 8, wherein the web-based graphical user interface further comprises a list of upcoming activities for the student.

13. The method according to claim 8, wherein the web-based graphical user interface further comprises a current learning objective module for the student, wherein the student can provide feedback commentary to the teacher in the current learning objective module.

14. The method according to claim 8, wherein the web-based graphical user interface further comprises media for the student that has been uploaded by the teacher.

15. A method for providing an individualized learning resource to a student, the method comprising:
executing, by a server, a web application, the web application creating a web-based graphical user interface associated with a parent account;
transmitting, from the server to a parent electronic device via the web-based graphical user interface, information comprising:
an assessment of a student learning progress in an academic subject or in relation to a learning objective;
a suggestion, based on the assessment of the student learning progress, to the parent of an individualized learning resource from a resource database that could assist the student in mastering an academic subject or a learning objective;
a feedback on the student learning progress provided by a teacher;
at least one of a document, a video or audio file, and other evidence of learning by the student; and
enabling, by the server, electronic communication between the parent account and a teacher account, the electronic communication providing the parent with immediate access to the teacher.

16. The method according to claim 15, wherein the web-based graphical user interface further comprises one or more learning objective modules for a student account linked to the parent account, the one or more learning objective modules defining the student's progress with respect to a learning objective.

17. The method according to claim 15, wherein the web-based graphical user interface further comprises a learning objective associated with the individualized learning resource that was selected for the student.

18. The method according to claim 15, wherein the web-based graphical user interface further comprises a list of upcoming activities for the student account that is linked to the parent account.

19. The method according to claim 15, wherein the at least one of a document, a video or audio file, and other evidence of learning by the student further comprises media associated with a sports or academic activity of the student.

20. The method according to claim 15, wherein feedback on the student learning progress provided by the teacher further comprises a personalized message from the teacher account to the parent account relative to the student's progress with respect to the academic subject or the learning objective.

21. A method for providing an electronic report card for a student, the method comprising:
executing, by a server, a web application, the web application creating a web-based graphical user interface associated with a parent account; and
transmitting, from the server to a parent electronic device via the web-based graphical user interface in the form of a report card, the report card comprising:
a selectable list of subjects, each of the subjects being associated with a grade, wherein selection of a subject of the list causes the display of learning objectives for the student, each of the learning objectives having an indication of whether the student completed or failed, wherein selection of a failed objective causes the display of teacher feedback that describes why the student failed at the learning objective.
